(19) United States
(12) Patent Application Publication
(10) Pub. No.: US 2009/0099965 A1
(43) Pub. Date: Apr. 16, 2009

(54) PREPAID EXPENSE CARD MANAGEMENT PLATFORM

(76) Inventor: Francis C. Grant, IV, New York, NY (US)

Correspondence Address: STRATEGIC PATENTS P.C.., C/O PORTFOLIOIP, P.O. BOX 52050, MINNEAPOLIS, MN, 55402, US

(21) Appl. No.: 12/194,628

(22) Filed: Aug. 20, 2008

Related U.S. Application Data
(60) Provisional application No. 60/957,098, filed on Aug. 21, 2007.

(51) Int. Cl. G06Q 40/00

(52) U.S. Cl. 705/41

(57) ABSTRACT

In embodiments of the present invention capabilities are described for a prepaid expense card management platform, where the management platform may be presented as a graphical user interface. The prepaid expense card management platform allows businesses to increase spending control and decrease overhead time associated with the administering of reimbursement expenditures. Controls enabled include funds allocation, funds transfer, user account administration, user access, spend rules, reports generation, usage profiles, conditional access, time usage restrictions, location usage restrictions, settlements processing, and alerts.

### CROSS-REFERENCE TO RELATED APPLICATIONS

This application claims the benefit of the following provisional application, which is hereby incorporated by reference in its entirety:

U.S. Provisional App. No. 60/957,098 filed Aug. 21, 2007.

### BACKGROUND

1. Field

The present invention is related to prepaid cards, and specifically to a prepaid card management platform with a graphical user interface and applications toward expense management.

2. Description of the Related Art

The spending profiles common among businesses present a favorable market environment for card-based payment products. Many vendors are adopting card payments to provide customers with more choice and to accelerate the process of getting paid. As payers and recipients rely more heavily on electronic payments to transact business, which will grow beyond general retail merchant relationships, the use of paper-based payment products will decline. The needs and sophistication of buyers and sellers will change, creating demand for ways to streamline the operational cost of managing expenses.

There is a need for prepaid corporate expense cards. The purchasing cycle can be split in two operational categories: the Decision to Buy and Payment. Payment tools such as credit cards and accounting software such as Quickbooks facilitate payments and organization of transactions in the Payment category, but few products help with the Decision to Buy category. There is a chasm between business owners keeping the full responsibility of approving transactions one by one and the possibility of easing some of that burden by enabling employees to control inadequacies of products available. Organizations understand that placing purchase responsibilities on employees pose risks, including: erroneous spending, theft and poor decision-making that can take time and money to resolve. These and other problems can be solved by using prepaid cards with strict spending management features built-in, and requiring no credit score to access. Card products available in the market today vary only slightly from each other. All have limited functionality and do little to provide owners with the controls needed to operate businesses more efficiently. Prepaid cards can provide these valuable controls, will dramatically improve the ways small businesses track and control spending, and help limit numerous points of risk for business owners.

### SUMMARY

The present invention provides improved capabilities for a prepaid expense card management service and/or platform, where the management platform may be presented as a graphical user interface. The prepaid expense card management platform allows businesses to increase spending control and decrease overhead time associated with the administering of cash and check disbursement expenditures.

The prepaid expense card management platform may include and/or be associated with an account administration facility, a funds management facility, the ability to auto-fund, a spend rules facility, a permissions facility, a data collection facility, portals, a graphical user interface, a payment network, a reporting engine, customer support functionality, an integrated voice response service, a billing engine, an alert engine, a search engine, a workflow engine, a community and forum, various types of users, various forms of platform access and real-time updates and information.

In embodiments, the prepaid expense card management platform may provide a user with a plurality of functions and controls, such as manage profiles (create, store, edit, terminate the customer business, customer administrator and card demographic information on file), administer card accounts (generate account number, create account record, store account record, change card status, change card account balance, change spend rules, terminate card account, create request for personalized or non-personalized encoded card plastic), set spend rules (create, store, cancel daily limits, frequency limits, day of the week limits, time of day limits, merchant limits by defined category or merchant category code (MCC), network message data limits), define spend rules (create, edit and store user defined spending limitation per card or business program or modify current MCC category groupings), override spend rules on an ad hoc basis, systematic notifications (alerts posted to dashboard, sent via email, sms, mobile, customer service), manage access permissions (business administrator functionality, cardholder functionality, customer service functionality) service accounts (search stored records by business customer name, cardholder name, card account number, bank account number, administrator name, business owner name, email, system username, phone number, review stored accounts including profile, balance and transaction history, edit stored accounts, terminate stored accounts, refund/waive fees, release authorization holds), process network messages (authorization, settlement, reversal, advice), administer program fees (waive fees, store fee structure, modify fee structure), manage business funds (create and cancel one-time and scheduled ACH transfer funding requests, add/remove funds from card accounts, create funding rules for card accounts, manage linked business operating accounts, calculate burn rate and suggest funding amount), close business customer program (block all cards, move card and program funds, produce reports), use workflows (request business funding, request card funding, request spend authorization, receive authorization, new customer applications, application approval/decline notification, score applicants, identity verification), create workflow tickets, change workflow ticket status, attach documents to tickets, generate ticket emails, display, hear or download transaction data for business and card (as list, as user defined report, as pre-defined report, as expense report, as monthly statement, as graph or chart, as detail, as aggregate, as machine readable file, as 3rd party proprietary format, as email, as mobile message, as voice message, as customer service agent call, as IVR/VRU), add comments to transaction record for business and card, date setting, access to all audit trails, limit viewing of audit trails to those with a job-related need, protect audit trail files from unauthorized modifications, or the like. These functions and controls may be provided through or enabled through a graphical user interface. In an embodiment, the graphical user interface may be provided using a web browser, client side program or the like. Access to the platform, such as via the user interface, may be provided via a computer, network, laptop, handheld device, cell phone, wireless email device, Treo, Blackberry, personal digital assistant, palm top computer, pager, digital music player, a voice interface, telephone access and the like.

In embodiments, the platform may provide methods and systems for managing expenses using prepaid cards, comprising providing a first account managed by a prepaid expense card management platform; providing at least one other account managed by the prepaid expense card management platform; and providing an account administration facility for allowing a user of the first account to perform at least one administrative action in connection with the at least one other account. In embodiments, the platform may provide methods and systems for managing expenses using prepaid cards, comprising providing a first account managed by a prepaid expense card management platform; providing at least one other account managed by the prepaid expense card management platform; and providing a funds management facility for allowing a user of the first account to perform at least one funding action in connection with the at least one other account.

In embodiments, the platform may provide methods and systems for managing expenses using prepaid cards, comprising: providing a first account of managed by a prepaid expense card management platform; providing at least one other account managed by the prepaid expense card management platform; and providing a funds management facility which transfers funds between the first account and the at least one other account. In embodiments, the platform may provide methods and systems for managing expenses using prepaid cards, comprising: providing at least one account managed by a prepaid expense card management platform; issuing at least one prepaid expense card associated with the at least one account to at least one user; and providing a spend rules facility for the administration of spend rules in association with the at least one account.

In embodiments, the platform may provide methods and systems for managing expense payments using prepaid expense cards, comprising providing a prepaid expense card management platform; and issuing at least one card associated with the platform to at least one individual. In embodiments, the platform may provide methods and systems for managing expenses using prepaid cards, comprising providing a prepaid expense card management platform, wherein the management platform is presented as a graphical user interface; issuing at least one prepaid card associated with the platform; and enabling management of the at least one prepaid card through the platform.

### BRIEF DESCRIPTION OF THE FIGURES

The invention and the following detailed description of certain embodiments thereof may be understood by reference to the following figures:

FIG. 1 depicts an embodiment of the prepaid expense card management platform.

FIG. 2 depicts an embodiment of the account administration facility.

FIG. 3 depicts an embodiment of the funds management facility.

FIG. 4 depicts an embodiment of the prepaid expense card management platform GUI, showing the initial applications process screen asking for personal information.

FIG. 5 depicts an embodiment of the prepaid expense card management platform GUI, showing a screen for entering bank information.

FIG. 6 depicts an embodiment of the prepaid expense card management platform GUI, showing a screen for entering credit card and billing address information.

FIG. 7 depicts an embodiment of the prepaid expense card management platform GUI, showing a table for entering a user's estimate for weekly petty cash.

FIG. 8 depicts an embodiment of the prepaid expense card management platform GUI, showing an initial funding screen.

FIG. 9 depicts an embodiment of the prepaid expense card management platform GUI, showing a confirm transfer screen for initial funding.

FIG. 10 depicts an embodiment of the prepaid expense card management platform GUI, showing a confirmation screen for initial funding.

FIG. 11 depicts an embodiment of the prepaid expense card management platform GUI, showing an employee name entry screen.

FIG. 12A depicts an embodiment of the prepaid expense card management platform GUI, showing an employee spend locations screen.

FIG. 12B depicts an embodiment of the prepaid expense card management platform GUI, showing an employee spend merchant categories screen.

FIG. 13 depicts an embodiment of the prepaid expense card management platform GUI, showing the dashboard interface.

FIG. 14 depicts an embodiment of the prepaid expense card management platform GUI, showing the card interface.

FIG. 15 depicts an embodiment of the prepaid expense card management platform GUI, showing 1 of 3 of the card management registering employee screen.

FIG. 16 depicts an embodiment of the prepaid expense card management platform GUI, showing 2 of 3 of the card management registering employee screen.

FIG. 17 depicts an embodiment of the prepaid expense card management platform GUI, showing 3 of 3 of the card management registering employee screen.

FIG. 18 depicts an embodiment of the prepaid expense card management platform GUI, showing 1 of 3 of the card management terminating employee screen.

FIG. 19 depicts an embodiment of the prepaid expense card management platform GUI, showing 2 of 3 of the card management terminating employee screen.

FIG. 20 depicts an embodiment of the prepaid expense card management platform GUI, showing 3 of 3 of the card management terminating employee screen.

FIG. 21 depicts an embodiment of the prepaid expense card management platform GUI, showing the card management view transactions screen.

FIG. 22 depicts an embodiment of the prepaid expense card management platform GUI, showing 1 of 4 of the card management add funds screen.

FIG. 23 depicts an embodiment of the prepaid expense card management platform GUI, showing 2 of 4 of the card management add funds screen.

FIG. 24 depicts an embodiment of the prepaid expense card management platform GUI, showing 3 of 4 of the card management add funds screen.

FIG. 25 depicts an embodiment of the prepaid expense card management platform GUI, showing 4 of 4 of the card management add funds screen.

FIG. 26 depicts an embodiment of the prepaid expense card management platform GUI, showing 1 of 4 of the card management remove card funds screen.

FIG. 27 depicts an embodiment of the prepaid expense card management platform GUI, showing 2 of 4 of the card management remove card funds screen.

FIG. 28 depicts an embodiment of the prepaid expense card management platform GUI, showing 3 of 4 of the card management remove card funds screen.

FIG. 29 depicts an embodiment of the prepaid expense card management platform GUI, showing 4 of 4 of the card management remove card funds screen.

FIG. 30 depicts an embodiment of the prepaid expense card management platform GUI, showing 1 of 2 of the card management block/unblock cardholder spend screen.

FIG. 31 depicts an embodiment of the prepaid expense card management platform GUI, showing 2 of 2 of the card management block/unblock cardholder spend screen.

FIG. 32 depicts an embodiment of the prepaid expense card management platform GUI, showing the card management total funds on cards screen.

### DETAILED DESCRIPTION

The present invention provides a prepaid expense card service 102 that may incorporate all the best features of cash, checks, corporate credit, corporate debit, prepaid cards, and the like. The service provided by the present invention may be referred to as the prepaid expense card management platform 102. To enroll in the prepaid expense card management platform 102, a user may submit an application through a prepaid expense card management platform website, via mail, email, fax, telephone, and the like, and may be followed by a number of setup procedures. Once setup procedures are complete, users, such as business owners or assigned administrators, may access the prepaid expense card management platform's features and product functionality under a plurality of categories, such as account profile management, funds management, card management, transaction management, help and facts knowledge base, and the like. In embodiments, the prepaid expense card management platform 102 may be a financial resource for small business owners by creating payment products that transition petty cash spending from paper to electronic-based spending tied to physical and virtual card numbers, automating the controls for and maintenance of employee-driven (and/or contractor-driven) spending electronically, as opposed to the manual processes for storage, tracking and monitoring.

In embodiments, the prepaid expense card management platform card may be implemented through a branded third party payment network and may feature a prepaid expense card management platform logo and design. In embodiments, the third party may be MasterCard, Visa, Discover and the like. In addition, for business applications, the logo and design may be conservatively implemented for appeal to the business market. The prepaid expense card management platform card may have features that are typically associated with credit cards and debit cards, such as a logo, hologram, magnetic strip on the back, signature panel, cardholder name, account information, expiration date, security code, embosed print, and the like. ATM or other PIN access may not be available for some cards, and thus may be limited to signature spending. Card package contents may be assembled by a fulfillment facility authorized by a third party to emboss and store cards, and may include card, card mailer, envelope, cardholder terms and conditions and the like. In embodiments, user information, such as terms and conditions, may be available on-line, via mail, via email, through a network or by other means.

In certain embodiments, the prepaid expense card management platform card may be a network branded prepaid card which may utilize a payment network, or system, such as Visa, MasterCard, American Express or Discover to facilitate the transfer of funds from an issuing bank to a merchant at the point of sale, or may utilize an ATM network, such as Plus, Cirrus, Star, Most, Nyce, Interlink, and the like, to facilitate transfer of funds from an issuing bank to the cardholder in the form of cash. In embodiments, the transaction may travel through a network's infrastructure to transact a purchase. In certain embodiments, the network logo may appear on the face or the back of the card and sometimes not.

In certain embodiments, the balance in the account which may be associated with the prepaid expense card management platform card may be the amount available for spending. In certain embodiments, borrowing may not be permitted and funds are to be added to an account prior to spending. In one particular an embodiment, the platform may utilize only one bank account where all card balances are pooled as opposed to a debit card where cash is stored in an individual demand deposit account in the account owner's name. In another embodiment, the prepaid expense card management platform may offer loans and/or overdraft protection and/or may allow for funding to be obtained from loans and/or overdraft protection. A database and transaction processing system may be charged with accurately tracking funds available for spending.

In certain embodiments, the prepaid expense card management platform card may be an expense card for which funds on deposit are owned by a business entity, not by a cardholders The funds may be prepaid funds. The card may be issued to an employee and/or contractor to facilitate corporate purchases. This embodiment may not function as an expense reimbursement program where employees and/or contractors pay business expenses out of pocket and expect a reimbursement from their employer either on a card or as a check.

In certain embodiments, the prepaid expense card management platform card and/or platform 102 may have one or more of the following properties: Funds may or must be deposited into an account prior to spend; funds may be stored in a pooled account and some technical device or database may track spending and balances electronically, there may be no transfer of ownership of funds when money is allocated to a card—the money always belongs to the business; and cards may be issued to authorize designated employees and/or contractors to spend company money on business expenses.

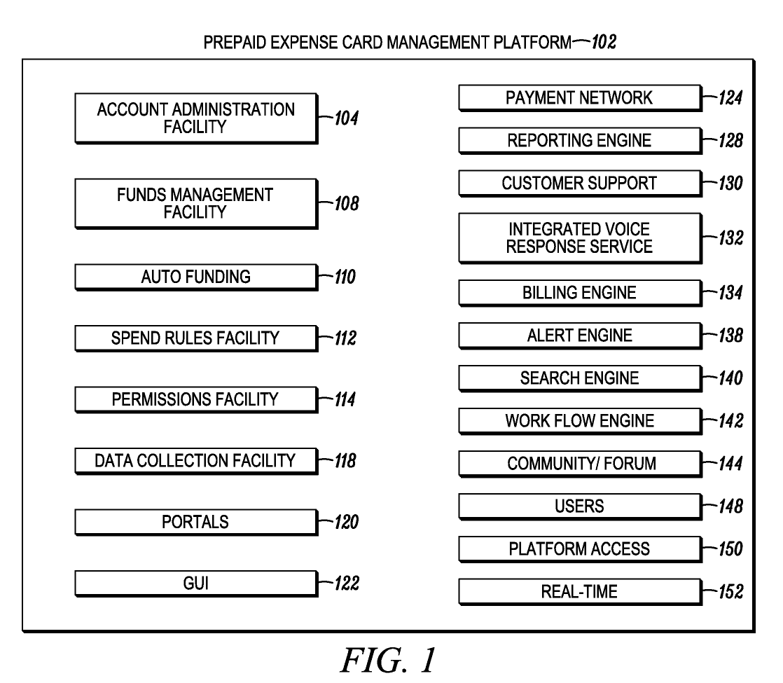

Referring to FIG. 1, the prepaid expense card management platform 102 may include and/or be associated with an account administration facility 104, a funds management facility 108, the ability to auto-fund 110, a spend rules facility 112, a permissions facility 114, a data collection facility 118, portals 120, a graphical user interface 122, a payment network 124, a reporting engine 128, customer support functionality 130, an integrated voice response service 132, a billing engine 134, an alert engine 138, a search engine 140, a workflow engine 142, a community and forum 144, various types of users 148, various forms of platform access 150 and real-time updates and information 152.

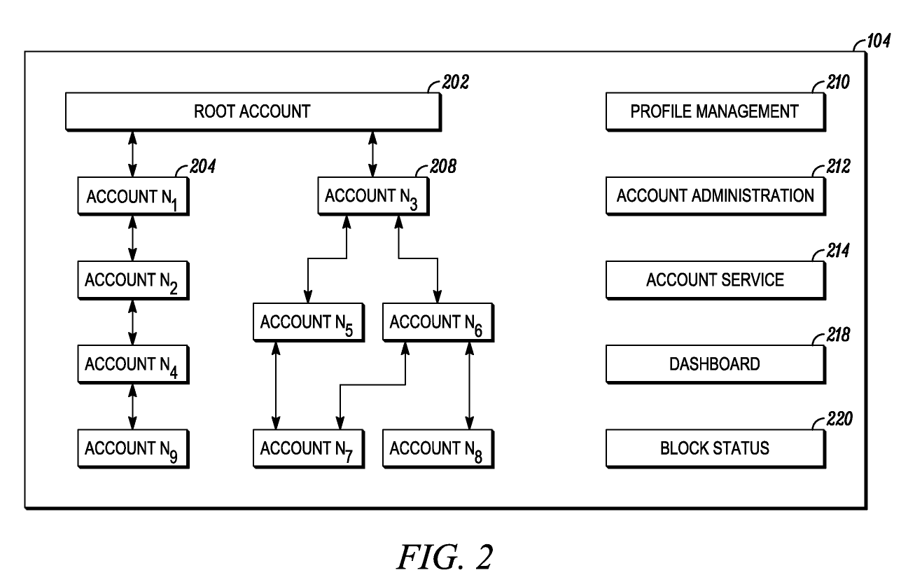

The prepaid expense card management platform 102 may include an account administration facility 104. Referring to FIG. 2, the account administration facility 104 may enable administration of various accounts and levels of accounts on the platform 102. An account may be a root account 202 from which all other accounts on the platform 102 may be managed. A root account 202 may allow for management of the various accounts of various business on the platform 102. Various accounts may be associated with a business. Accounts may be associated with different businesses. Referring to FIG. 2, account 204 may be associated with a different business than account 208. Certain of the accounts may allow for management of certain other accounts associated with a business. For example, an administrator account may allow for management of all the accounts of the business. In embodiments, an account for a division manager may allow for administration of the accounts of members of the division. In embodiments, a given account may be permitted to administer any set of other accounts as determined by the platform 102 or a higher level account.

The account management facility 104 may enable the management of profiles and/or accounts 210. The account management facility 104 may enable creation, storing, editing and termination of profiles and/or accounts. The account management facility 104 may allow for the termination of a business or particular account. The account management facility 104 may enable manipulation of card demographic information. The account management facility 104 may enable the administration of accounts 212. In embodiments, administration 212 may include generating account numbers, creating account records, storing account records, changing card status, changing card account balance, changing spend rules, terminating card accounts, creating requests for personalized or non-personalized cards and the like. The account management facility 104 may allow for batch administration. In an embodiment, the account management facility 104 may allow for a change of parameters to be applied to all or a group of accounts. The account management facility 104 may allow for the creation and termination of administration accounts. The account management facility 104 may allow for the creation and termination of card accounts.

The account management facility 104 may enable account service 214. Account service 214 functions may include searching stored records by business customer name, cardholder name, card account number, bank account number, administrator name, business owner name, email, system username, phone number and the like, reviewing stored accounts including profile, balance and transaction history information, editing stored accounts, terminating stored accounts, refunding and/or waiving certain fees, releasing authorization holds and the like. The account management facility 104 may also allow for registration and termination of employees and/or contractors, card issuance, viewing spend transactions by account, activation and deactivation of cards and the like.

The account management facility 104 may provide for an administration dashboard 218, that may include a cardholder list, cardholder balance, card active/block status, click-through to card account for more detail functionality, and the like. The account management facility 104 may allow a user to place one or more accounts into a state of suspension/inactivity or block status 220. Block status 220 may be temporary and a user may be restored to active status. In an embodiment, a user on vacation may be assigned block status 220. Account profile management may be available, with client company profile listing authorizing users and passwords for system access, registered bank account information, a view of available program balance information such as money on deposit and unallocated to cards, and the like.

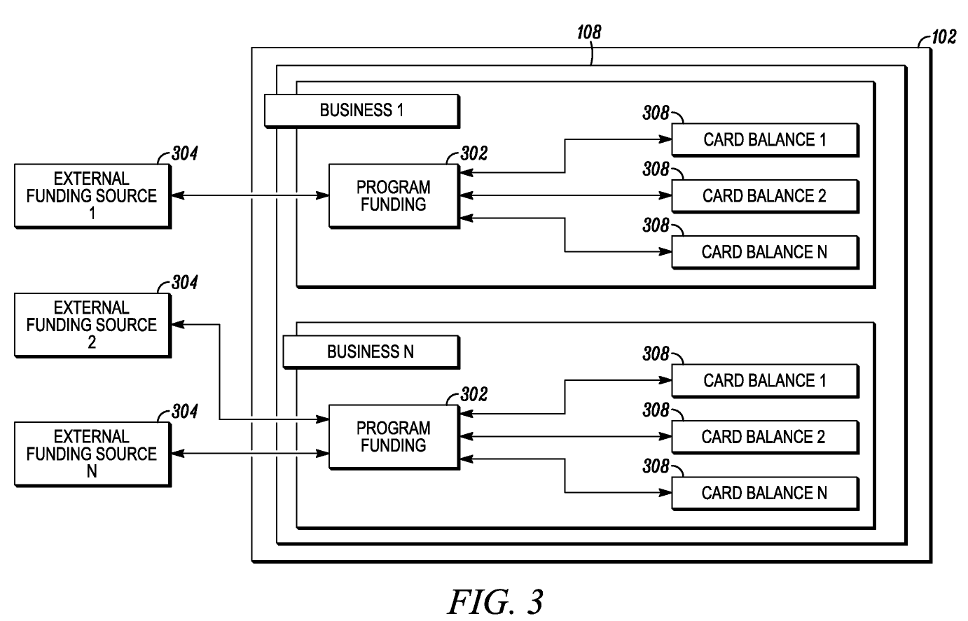

The prepaid expense card management platform 102 may include a funds management facility 108. Referring to FIG. 3, program funding 302, that is, the money customers keep on deposit with the prepaid expense card management platform, may come from external funding sources 304, such as from credit cards, lines of credit, cash deposits, loans or the like. In embodiments, program funding 302 may be largely or completely from cash deposits, where funds transfers may be available through a prepaid expense card management platform or card funding service, a third party funds transfer service, customer initiated funding via a banking websites' bill pay service online, a customer initiated wire transfer service, ACH transfer, or the like. The funds transfer service may be a system module enabling funds transfers from registered bank accounts to prepaid expense card management platform card accounts on the prepaid expense card management platform. Incoming funds may be reflected on the site as the prepaid expense card management platform account balance representing pooled business/expense funds prior to card account disbursement. During the customer account setup process, business bank account information may be registered online with the prepaid expense card management platform. Funding from a bank website may provide bill pay services enabling customers to initiate electronic payments from their accounts to designated payees. A prepaid expense card management platform card or the prepaid expense card management platform may be registered on the electronic payment networks as a payee (similar to utilities and other vendors) to receive payments initiated from bank websites. Wire transfers may be setup to receive wire transfers from customers who may need same day funding services. The program funding 302 may be allocated, in whole or in part, to one or more accounts, each with an associated card balance 308.

The funds management facility 108 may enable management of business funds, including, without limitation, creating and canceling one-time and scheduled ACH transfer funding requests, adding and removing funds from card accounts, creating funding rules for card accounts, managing linked business operating accounts, calculating bum rate, suggesting funding amounts and the like. The funds management facility 108 may also process network messages, including, without limitation, authorization, settlement, reversal and advice. The funds management facility 108 may enable adding and removing of card funds and manipulation of card balances. In embodiments, the cards may be re-loadable. In embodiments, the card funds may not be the property of the cardholders

The funds management facility 108 may enable funds management, such as for inbound and outbound funds management; inbound funds balance stored as ‘available balance’ or funds received notifications sent to authorized administrators, such as unable to load cards until funds arrival is confirmed; outbound, such as routing funds back to an external back account; addition and removal of cards; automatic load rules, such as a top-off feature that systematically adds funds to meet maximum card balance available, and set to occur at regular times, such as daily, weekly, monthly; or the like.

The funds management facility 108 may enable auto-funding 110 of particular accounts. In embodiments, the auto fund rule may be configured to fund only if needed, and not arbitrarily. The auto fund feature 110 may reduce the amount of work required by administrators. The auto fund feature 110 may ensure that cards are allocated funds in a timely fashion. In an embodiment, a card holding sales person may begin work at 7 am Eastern time, but the system administrator may not begin work until 9 am Pacific time. On a Monday morning, the sales person may not receive funds on her card until after noon Eastern time, but she may have needed funds before that time. With the auto fund feature 110 the administrator could have configured an auto fund rule to add the allowed balance to the sales person's card prior to 7 am Eastern time.

The prepaid expense card management platform 102 may include a spend rules facility 112. The spend rules facility 112 may enable the creation, administration and management of spend rules. In embodiments, spend rules may include a plurality of limitations, such as limited spend by MCC, category of expenditure, amount of expenditure or series of expenditures, amount per transaction, frequency of expenditures, time constraints such as daily, day of the week, time of day, weekly, or monthly spend limits, or the like. Spend rules may relate to employee and/or contractor working hours, geographical zones, locations, gratuity rules, days of the week, and the like, and how much the employee and/or contractor should be allowed to spend. In embodiments, spend rules implemented by the spend rules facility 112 may put limits on the total spend per transaction, per location, per category of expenditure, per time period and the like. In an embodiment, a spend rule implemented by the spend rules facility 112 may require the user who is spending and the transaction to occur in the same place, such as by determining the location of the user based on the location of the user's cell phone, vehicle and the like. The spend rule may be defined by the business customer. The spend rule may require the employee and/or contractor to seek manager authorization prior to purchase.

The spend rules facility 112 may allow a user to set spend rules, including, without limitation, the creation, storing and cancellation of spend rules. The spend rules facility 112 may allow a user to very the parameters of a certain spend rule. In embodiments, the spend rules facility 112 may allow a business administrator to vary the spending limits on certain account in real-time and to change the limits for certain categories of merchants. For example, if the price of fuel increases in a particular day, the administrator may increase the amount certain users who are company drivers can spend on fuel. The spend rules facility 112 may allow a user to override certain spend rules, such as on an ad hoc basis. In an embodiment, a user may receive a request to override a certain spend rule and may decide to honor such request. The spend rules facility 112 may allow for the definition of spend rules, including, without limitation, the creation, editing and storing of user defined spend rules. In an embodiment, a user may define the spending limitation per card or business program or modify the allowed MCC category groupings for certain accounts under such user's control. The spend rules facility 112 may allow for the implementation of certain spend rules or groups of spend rules. In an embodiment, the spend rules facility 112 may allow for the implementation of a global spend rule or a customized subset of spend rules applied to a selected group of users.

The spend rules facility 112 may allow for allow for spend rules to be applied on an account level, card level, subset of accounts level, program level, sub-program level, business level, globally and the like. The spend rules facility 112 may allow for spend rules to be represented visually, such as in a graphical user interface. The spend rules facility 112 may also enable spend rules approval requests. In an embodiment, a card holder may request variation of a certain spend rule via the spend rules facility 112. The spend rules facility 112 may also, alone or in conjunction with the alert engine 138, generate alerts relating to spend rules. In an embodiment, the spend rules facility 112 may send an alert to an administrator when a user attempts more than once to violate a spend rule in a given period of time. In another embodiment, the spend rules facility 112 may permit some predetermined percentage spend beyond a give spend rule, but notify an administrator of the same. In another embodiment, the spend rules facility 112 may generate an alert relating to failed authorization as a result of card misuse. An alert may be in the form of an email, a window in a graphical user interface, a text message, a phone call, a page and the like. The spend rules facility 112 may permit spend rules and related data to be updated and varied in real-time.

The prepaid expense card management platform 102 may include a permissions facility 114. The permissions facility 114 may manage access permissions, including, without limitation, business administrator functionality, cardholder functionality, customer service functionality and the like. The permissions facility 114 may permit conditional access. The permissions facility 114 may allow for variation of access levels and available features by class of user or by particular user. The conditional access level may be varied and specified using the permissions facility 114. Conditional access levels may be varied in real time or at set intervals. In an embodiment, a business owner or administrator may allow an accountant to have conditional access to the prepaid expense card management platform 102. The accountant may have the ability to view transactions and collect expense data, such as for book keeping and tax purposes, but may not have the ability to fund cards or change spend rules. In another embodiment, a business owner or administrator may opt-in to a service provided by the prepaid expense card management platform 102 in which a consultant is given limited access to the platform in order to review and audit the expenses of a business, group of users or one particular user. The consultant may then provide advice regarding how to reduce and consolidate expenses.

The prepaid expense card management platform 102 may include a data collection facility 118. The data collection facility 118 may enable the collection, aggregation, analysis, sharing and the like of various types of data associated with the platform 102. In an embodiment, the data collection facility 118 may collect and aggregate data, such as expense data, across various users of the platform and businesses using the platform. In another embodiment, a business owner or administrator may choose to opt into a data sharing program facilitated by the data collection facility 118. In exchange for sharing their data the business may receive access to aggregate data of users of the platform. The data may be aggregated or made available by expense type, industry, business size, business type and the like. The information may be provided or discussed in the forums or blogs 144 associated with the platform 102.

The prepaid expense card management platform 102 may be implemented through a plurality of portals 120, which may be tailored and designed for the user or a type or category of user. Types of portals 120 may include a main portal, a customer program administrator or user access portal, a cardholder site portal, a prepaid expense card management platform employee and/or contractor portal, a customer support portal and the like. The main portal may include a location on the web, an intranet or other network, with a home page, a product overview and descriptions section, fee descriptions, a customer login area, new customer application and payment of application fee feature, corporate information, and the like.

The cardholder site portal may include a login from a main site, a view of balance available, a view of spend transactions, and the like. The prepaid expense card management platform employee and/or contractor portal may include access in conjunction with job responsibilities, and provide access to groups within the organization, such as a technology group accessing modules for system monitoring, maintenance, and updates; a finance group accessing settlement reporting for bank and funding purposes and program loading for funds received from customers; a marketing group accessing reporting to assist with ad campaign management; and the like. The customer support portal may provide support agents a tool for accessing customer account records and system support details for handing calls from program administrators and cardholders, such as a customer support portal login page, customer account access, fee reversal and addition access, multi-tier access for supervisors and agents, knowledge base resources, FAQs resources, help resources, and the like.

The prepaid expense card management platform may present itself as a graphical user interface 122 (GUI or prepaid expense card management platform GUI) to users 148. The prepaid expense card management platform GUI 122 may be presented in a way that reflects the sense of a trusted financial institution, as for example, the prepaid expense card management platform 102 website may have similar appearances to websites for a bank or major branded credit card such as the use of similar colors, themes, and layouts, in order to provide the user with a sense of trust. In embodiments, the prepaid expense card management platform GUI 122 may be implemented as on-line or off-line, as a stand-alone application, as an interactive web based-application, or any combination thereof In embodiments, the prepaid expense card management platform GUI 122 may have functionality and design that promotes a sense that the prepaid expense card management platform GUI 122 is current, up-to-date, and cutting edge, such as the use of asynchronous Javascript and XML (Ajax), Comet, HTTP streaming, thumb nail viewers (such as viewers that allow a preview of a linked page before a user decides to click through to that page), the ribbon look such as on Microsoft 2007 products, tabbed down browsing, and the like, in keeping the website interactive, attractive, and convenient.

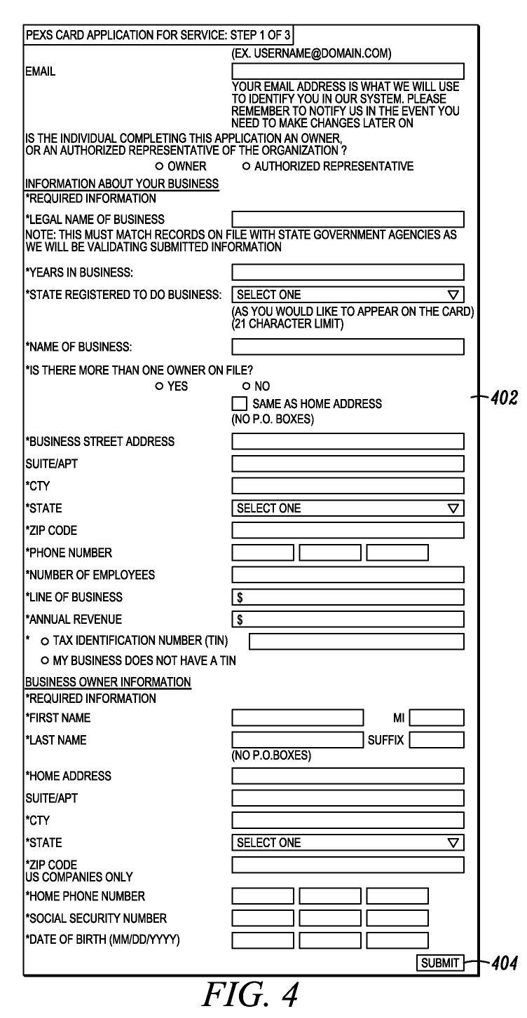

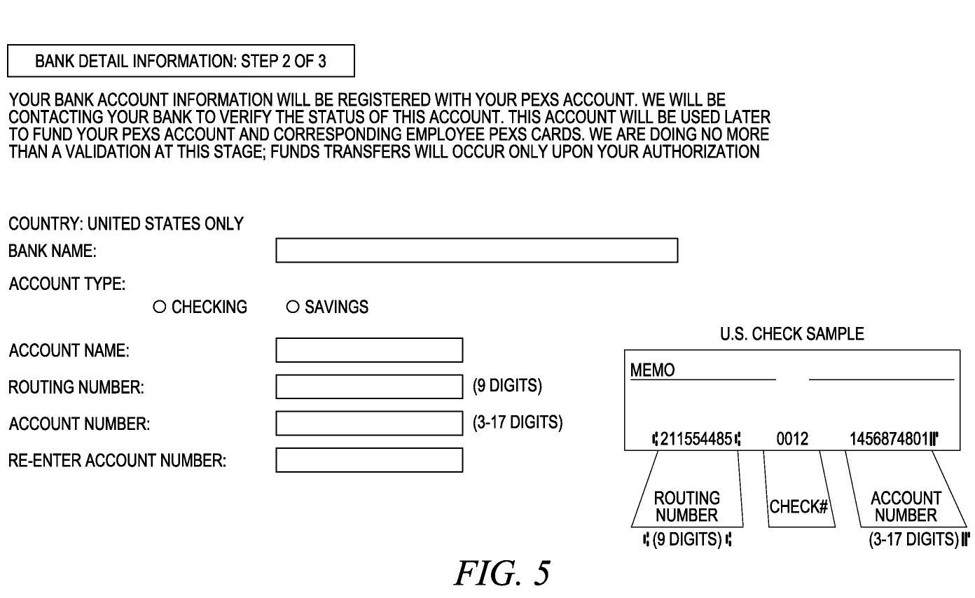

In embodiments, the user may be walked through the initial application and registration through the prepaid expense card management platform GUI 122. Initial functional sequences encountered by the user through the prepaid expense card management platform GUI 122 may include the applications process, the initial step-by-step introduction process, and the dashboard, which is a tool to provide the user with top-level information status of their program. FIG. 4 presents a screen depicting the initial applications process, where a user may be asked to complete a form 402 to provide information about their business and themselves, such as if they are a business owner or authorized representative of a company; personal information about the business owner, such as name, home, address, SSN, date-of-birth, phone number, email, demographic information, information regarding their authorization to open an account, and the like. The user may also be asked to select a username, password, security question/answer, provide bank account information, and the like. The user may also be asked to provide information about the business, such as the legal name of the business, years in business, type of business, D&B number, TIN/EID, industry sector, size of business, revenue, profit, and the like. The user may also be asked to present information such as bank account information and the like. When all required information has been entered, the user may select the submit button 404, as shown in FIG. 4, in order to enter the information into the system. In embodiments, bank account information may be submitted through a dedicated screen such as shown in FIG. 5. In embodiments, the relevant country may be the United States or a different country. In embodiments, a session may be saved so that a user can resume the application process at the point at which it was previously stopped.

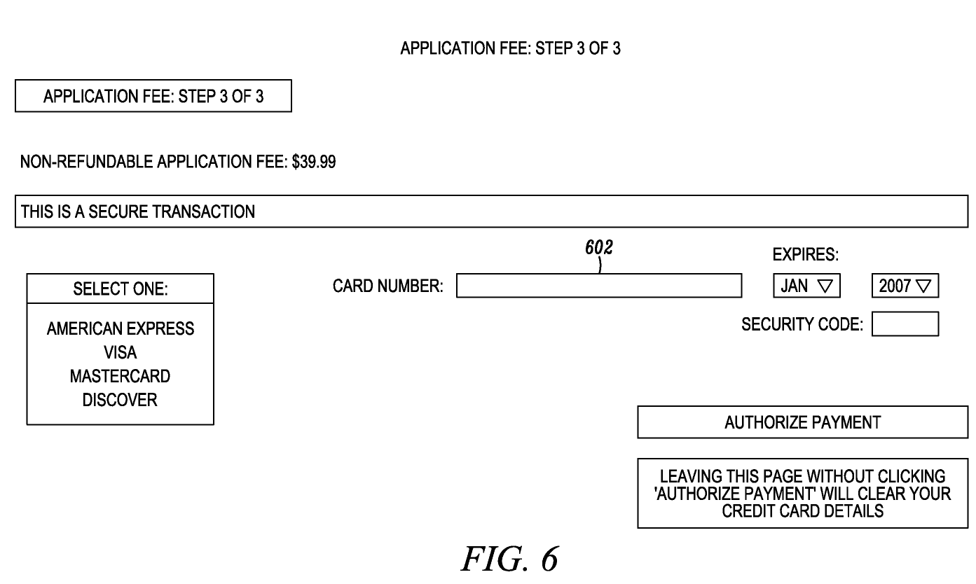

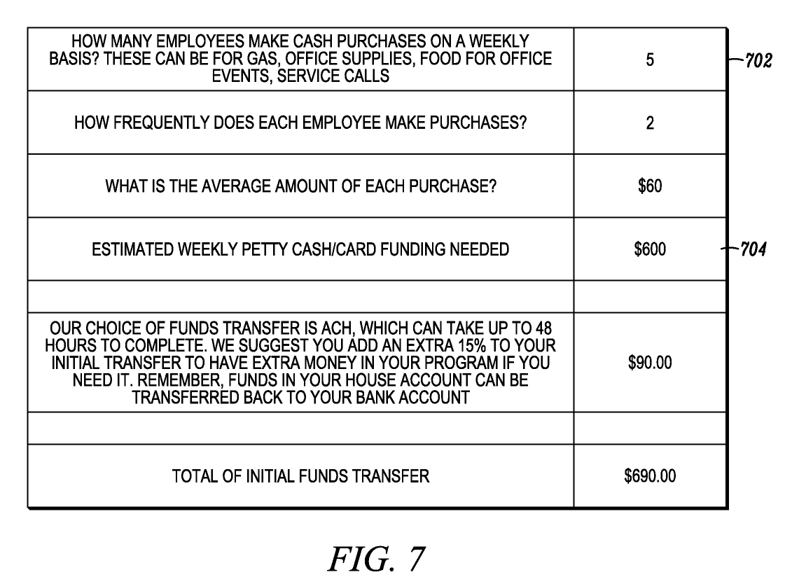

In embodiments, the prepaid expense card management platform GUI 122 may present a screen for collecting credit card and billing address information, such as shown in FIG. 6, and allow for the submission of the order. In an embodiment, a user may submit credit card information 602 which may be used for payment of fees and/or program funding. Submission of the order may be followed by an application confirmation, where the prepaid expense card management platform team or the platform itself may review the information submitted, verify the information against different sources for authenticity and/or assign a score to the applicant. The score may be used to determine whether to approve or deny the application. The prepaid expense card management platform may confirm and verify bank information, such as by originating two small outbound charges or deposits, which the user verifies upon accessing the platform. If everything or a sufficient amount is correct, the user may be notified of approval, and move to initial customer setup, where the user will be asked to transfer funds and register employees and/or contractors. Referring to FIG. 7, the user may also be asked to complete a questionnaire or series of questions 702 to estimate weekly petty cash needs. In embodiments, the prepaid expense card management platform GUI may provide an estimation calculator 704 to aid the user in this estimate, which if used, may fill a table 702, such as shown in FIG. 7, automatically. Users that already know their weekly petty cash needs may fill in this table manually.

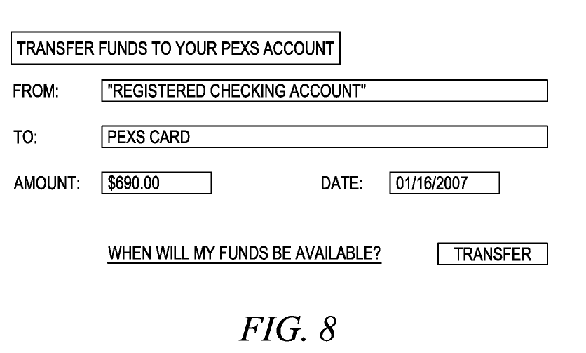

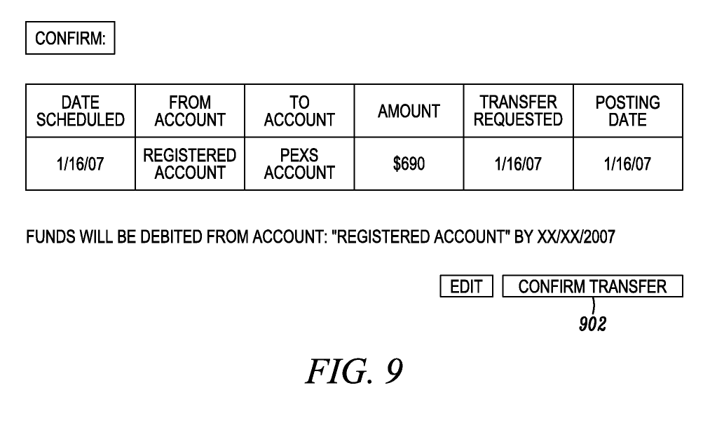

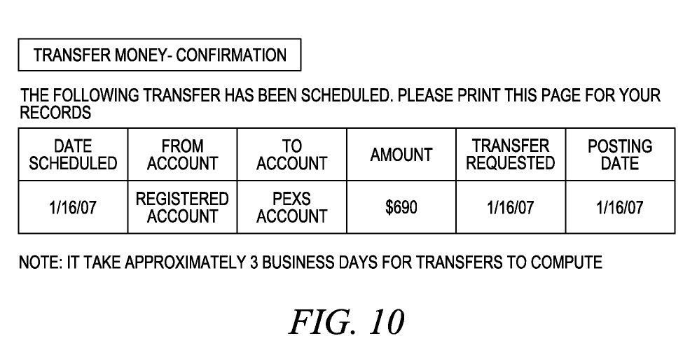

In embodiments, the user may now be asked to initiate funding, such as with prepaid expense card management platform GUI screen shown in FIG. 8. After entering funding information, the user may be presented with an opportunity to make changes before completing the process by clicking to confirm the transfer 902, such as shown in FIG. 9, and upon acceptance, be presented a confirmation page such as shown in FIG. 10. With the entry of funding information complete, the user may be asked if they wish to receive email or other notification if the house or other account falls below a certain threshold, which may be set by the user or another user, or auto transfer on a schedule so the account has a minimum dollar amount on a certain day. In embodiments, the user may be able to configure these rules.

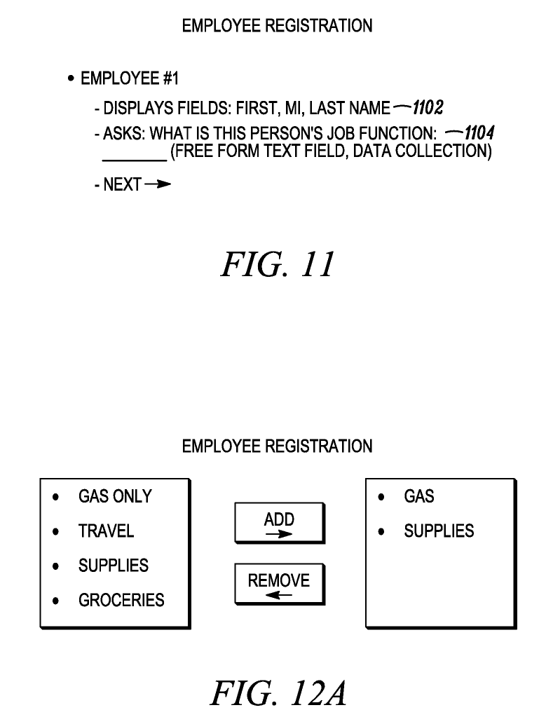

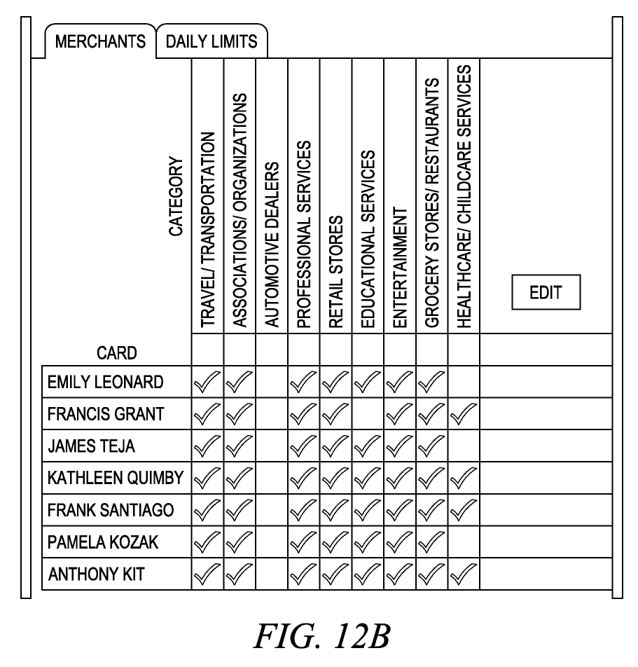

In embodiments, the user may now register employees and/or contractors. For instance, the prepaid expense card management platform GUI may walk the user through the process of entering employees and/or contractors into the system and issuing cards, cards may be sent individually to the business address used to file the prepaid expense card management platform card or prepaid expense card management platform account application and sent to the attention of the business owner or authorized administrator. Then the user may set up employee and/or contractor spending controls and may enter the names 1102 of the employees (and/or contractors) and related job functions 1104 as shown in FIG. 11 Title information or other information about the user may be collected. This information may be used to provide additional or automated services to the users. Further, it may be desirable to enter names that correspond to government ID numbers in the event that cashiers want to verify the cardholders The user may now detail spend locations based on pre-established groups, or entered in by the user, as shown in FIG. 12A. In addition, a screen may be presented for the user to enter employee (and/or contractor) working hours, with drop-downs for hours from/to, time-zones, geographical zones, locations, gratuity rules, days of the week, and the like, and how much the employee (and/or contractor) should be allowed to spend. Referring to FIG. 12B, in an embodiment, the platform 102 may permit the categories of spending to be defined for a given user or set of users. Merchant categories may include travel, transportation, associations, organizations, automotive dealers, professional services, retail stores, educational services, entertainment, grocery stores, restaurants, healthcare, childcare services and the like. Daily limits may also be specified. In embodiments, the user may put limits on the total spend per transaction, per location, per category of expenditure, per time period, by network message data and the like. The interface may offer a tool to create and/or modify a user-defined spend rule. After each employee (and/or contractor) registration, the system may display a confirmation page summarizing the employee's (and/or contractor's) name, spend locations, time of day, amounts, and the like. The user may be able to edit to make revisions, or click a “Submit” button to accept. When all employees (and/or contractors) are entered, a final list may be presented, and may be edited or submitted as complete. In embodiments, the dashboard screen may appear for the user to begin using the system.

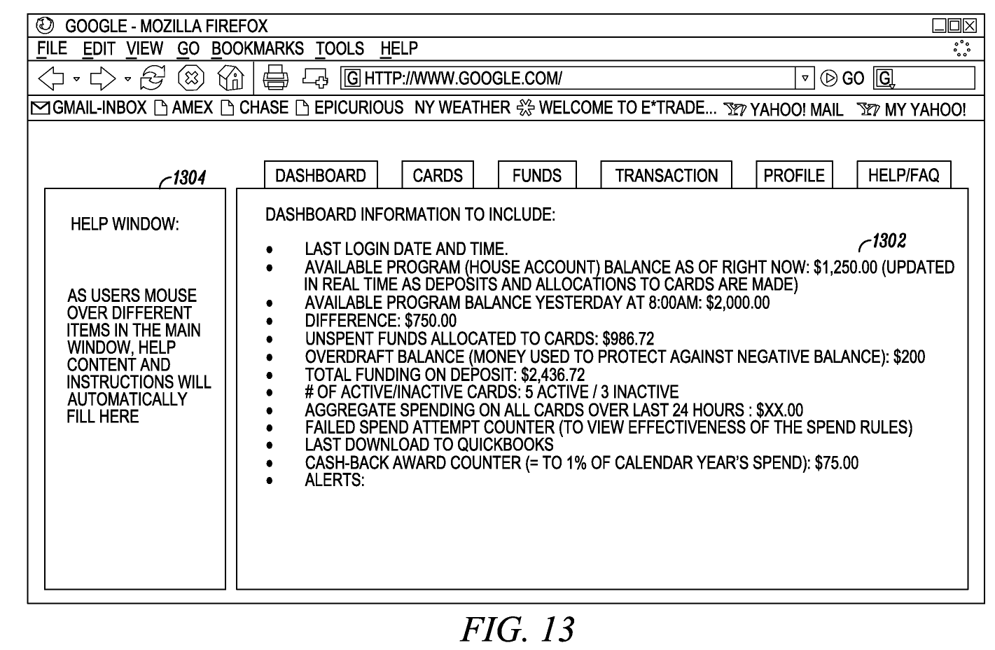

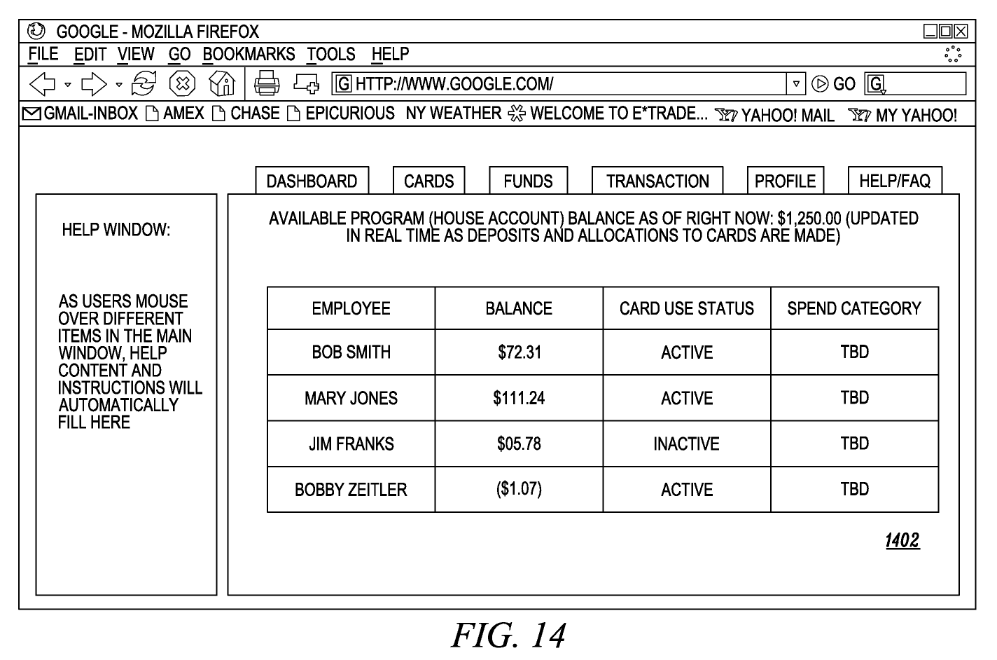

In embodiments, the user may now be directed into the prepaid expense card management platform GUI main page, with the dashboard screen displayed, a tool to provide the user with top-level information status of their program. In embodiments, the main screen and dashboard may be launch points to other operations, and also provide alerts and reminders about things like program funding, statement availability, and the like. FIG. 13 shows an example of the dashboard screen, along with an example of status information 1302 that may be provided. In addition to the dashboard screen, the main page provides other functions such as for cards, funds, transactions, profiles, help/FAQs, and the like. In this particular embodiment, as users mouse over various features help may appear on the screen 1304. In other embodiments, help windows or bubbles may appear. In other embodiments, help may not be provided or may be provided on a limited basis. The card management screen 1402, as shown in FIG. 14, provides the card management section containing all the control functionality for cards issued to employees (and/or contractors).

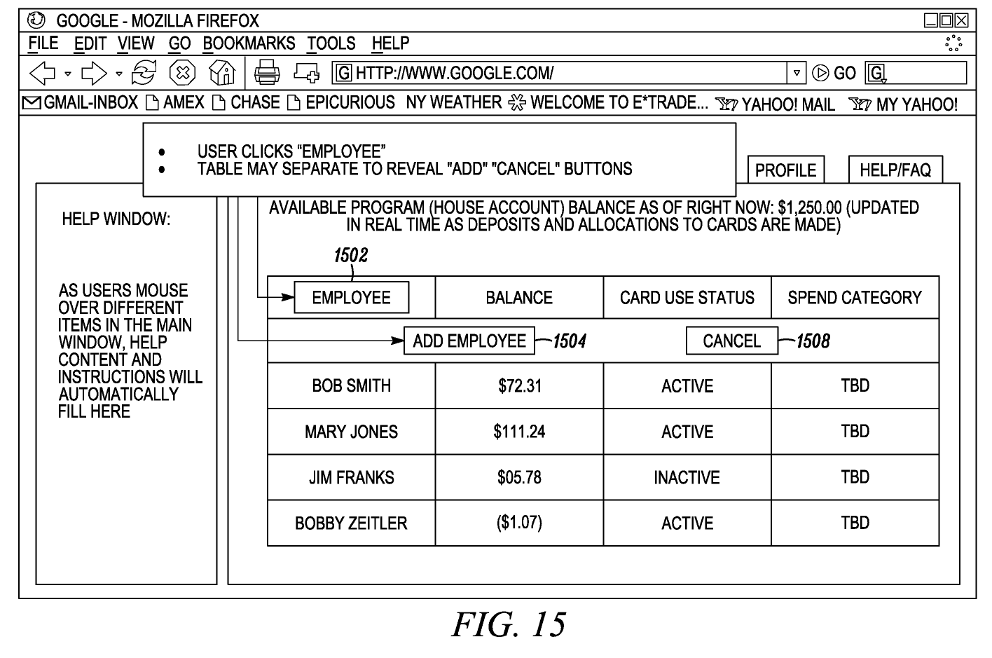

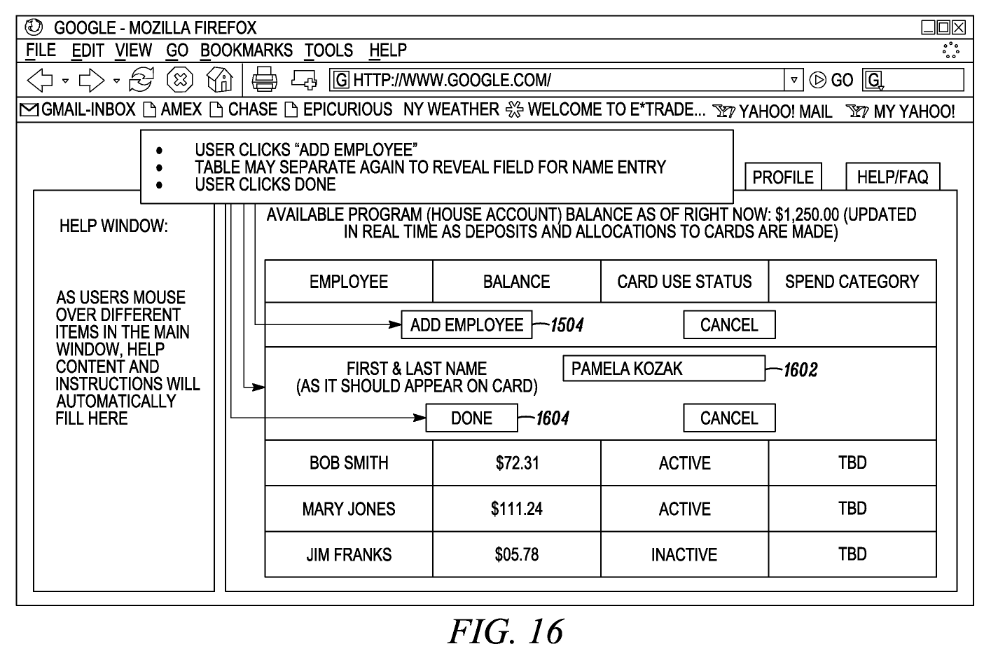

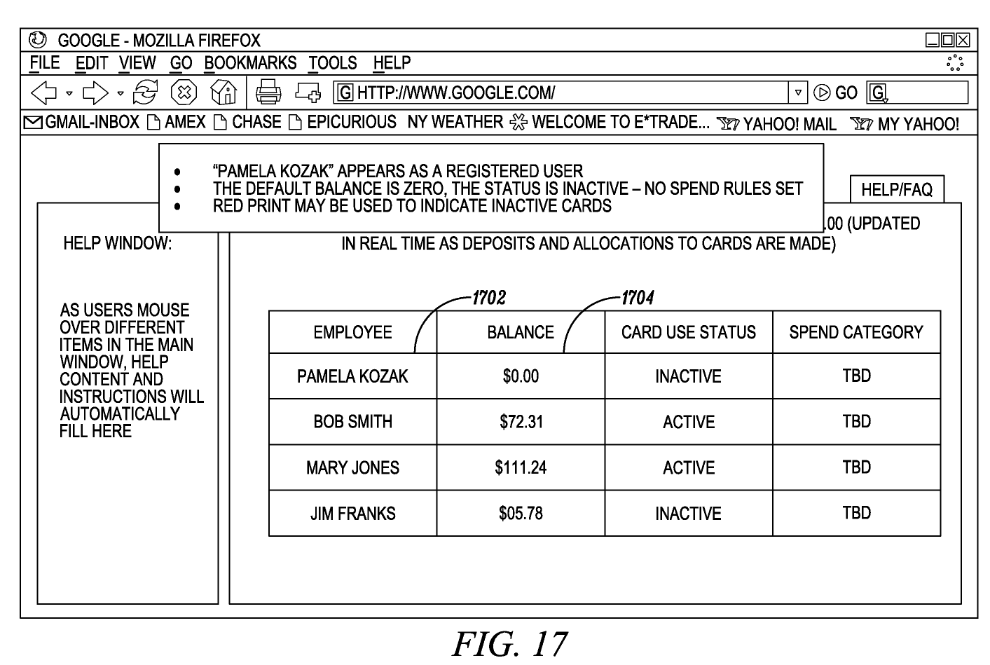

In embodiments, the GUI 122 may provide a plurality of additional user card management functions, such as for registering an employee (and/or contractor) as shown in FIGS. 15-17. Referring to FIG. 15, a user may click on an “Employee” button 1502 and a table may separate to reveal “Add Employee” 1504 and “Cancel” 1508 buttons. Referring to FIG. 16, a user may click “Add Employee” 1504 and the table may separate again to reveal a field of name entry 1602. Once the name is entered, the user may click the “Done” button 1604. Referring to FIG. 17, the new employee may now appear as a registered user 1702. The default balance 1704 may be set to $0.00 since no spend rules have been set. In addition, the default status may be set to inactive.

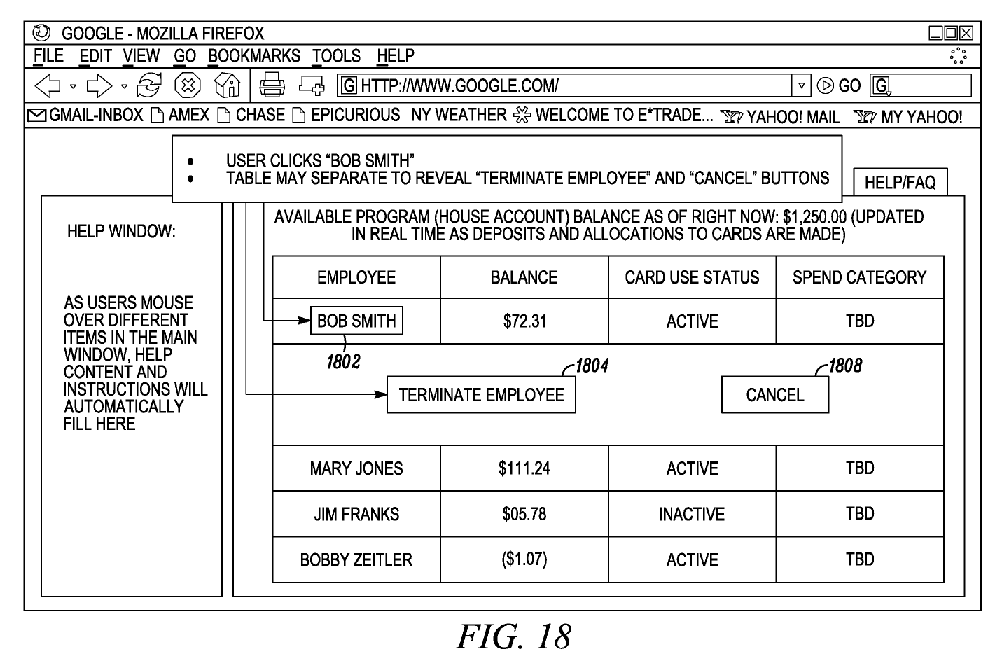

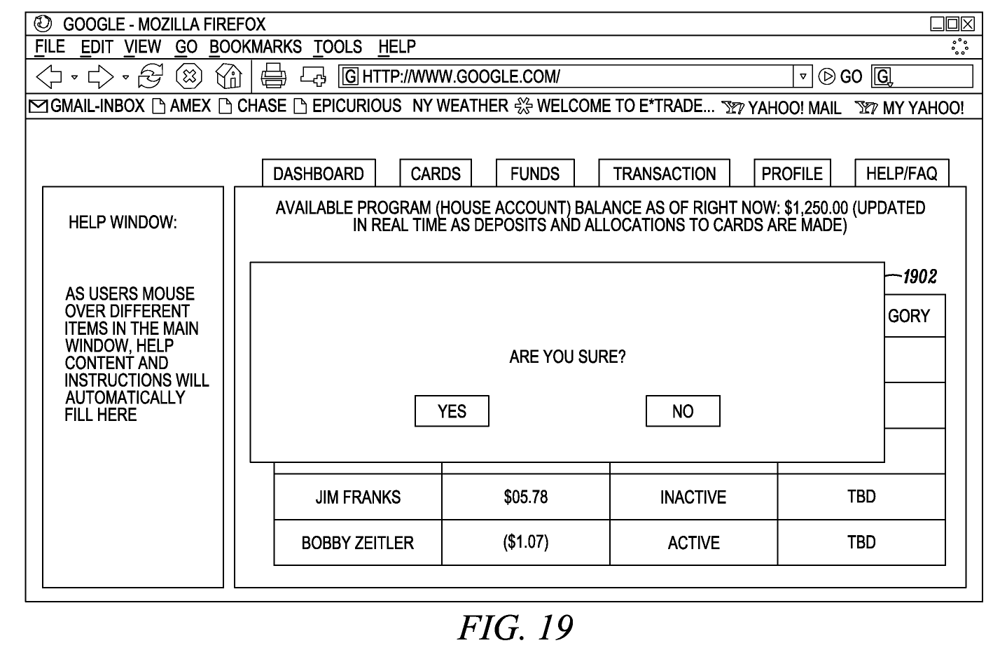

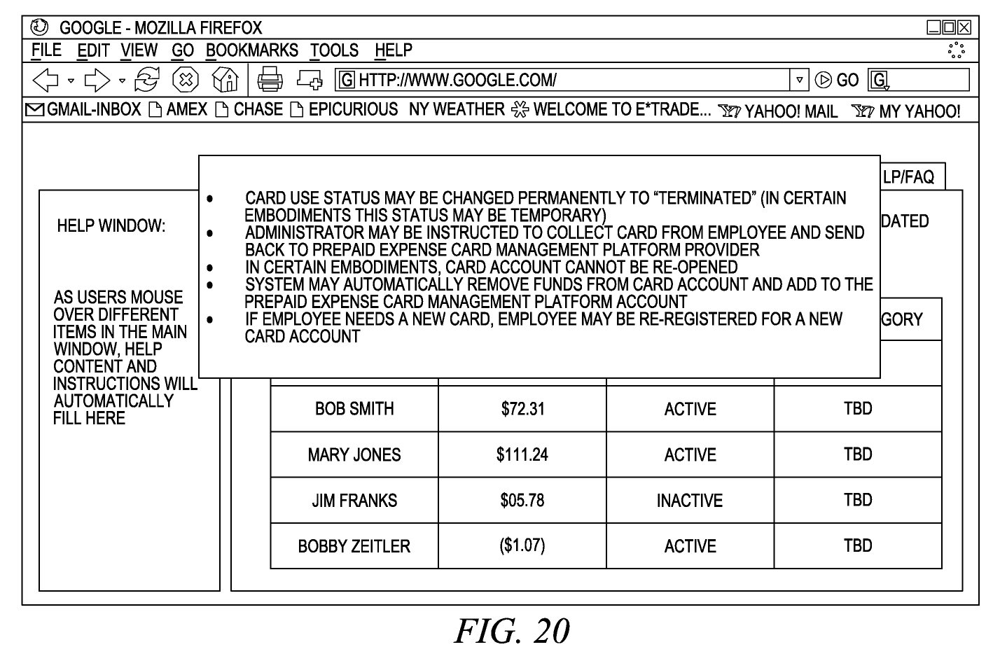

In embodiments, the GUI 122 may provide a plurality of additional user card management functions, such as for terminating an employee (and/or contractor) as shown in FIGS. 18-20. Referring to FIG. 18, a user may click on the name of a particular employee 1802 and the table may separate to reveal a button for “Terminate Employee” 1804 and a button for “Cancel” 1808. Referring to FIG. 19, the user clicks the “Terminate Employee” 1804 button, the user may be asked to confirm such selection 1902. Referring to FIG. 20, the card use status may be changed permanently or temporarily to “Terminated.” An administrator may be instructed to collect the card from the employee and send back the card to prepaid expense card management platform provider or destroy the card. In certain embodiments, the card account cannot be re-opened. In embodiments, the system may automatically remove funds from the card account and add to the program funding or prepaid expense card management platform account. In certain embodiments, if the employee needs a new card, the employee may be re-registered for a new card account. In other embodiments, the employee's account may be restored to active status from being temporary blocked or inactivated.

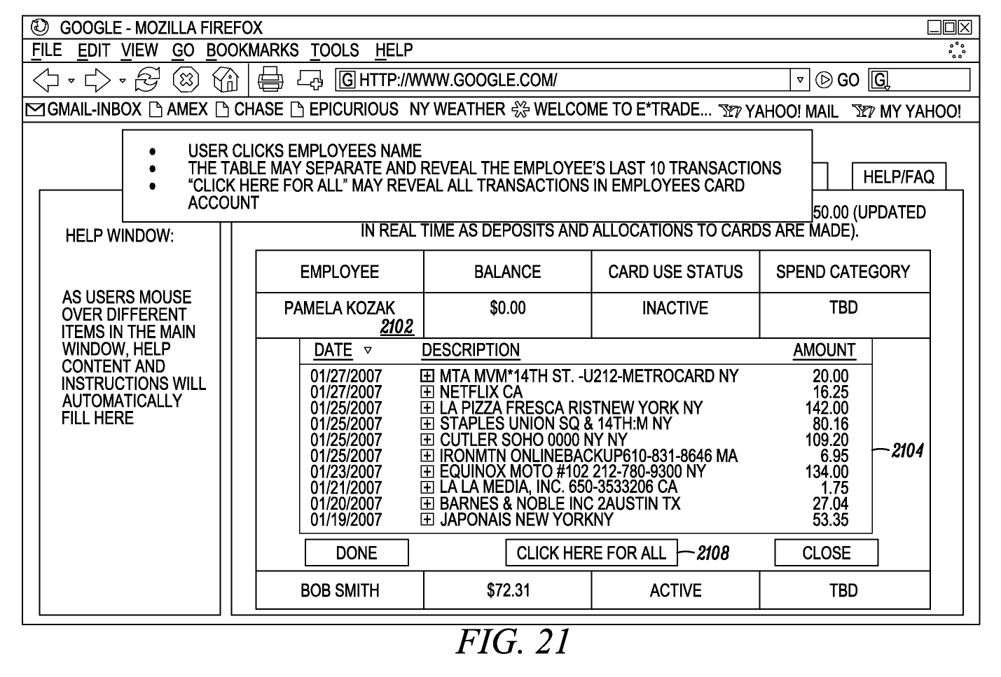

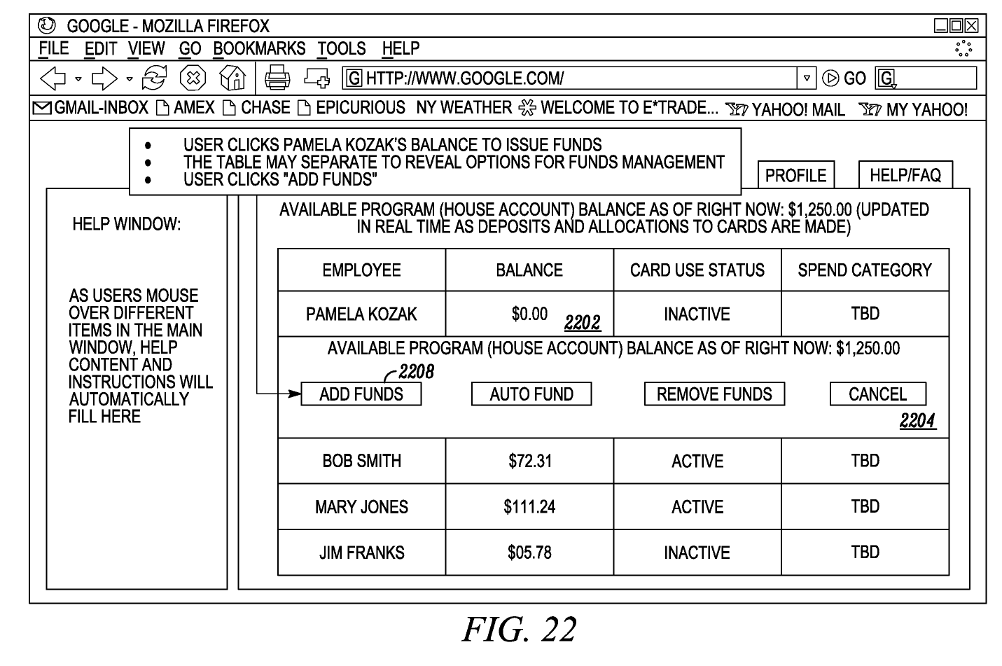

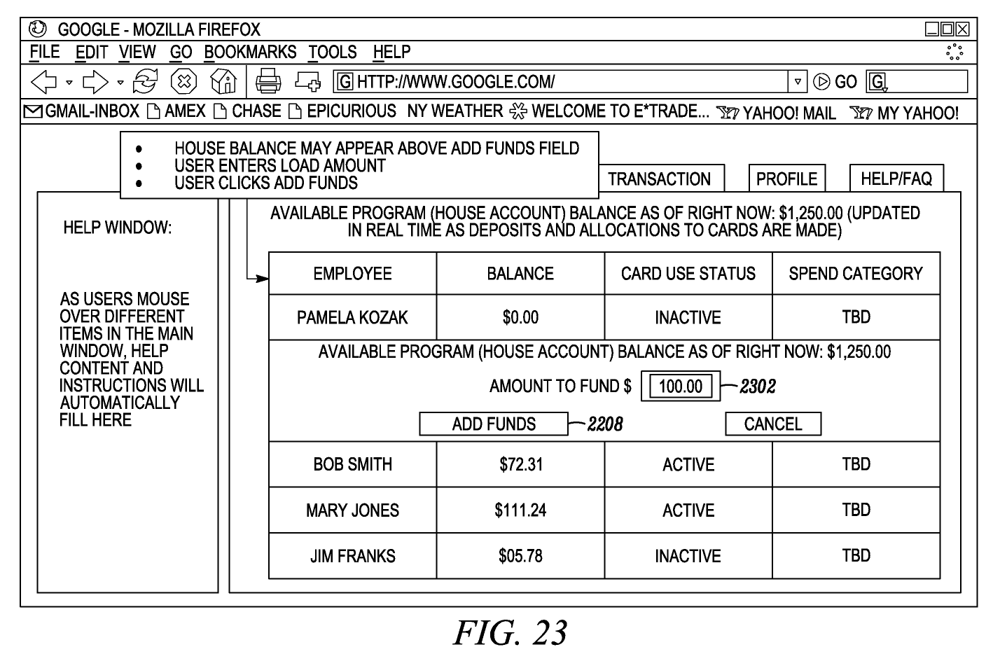

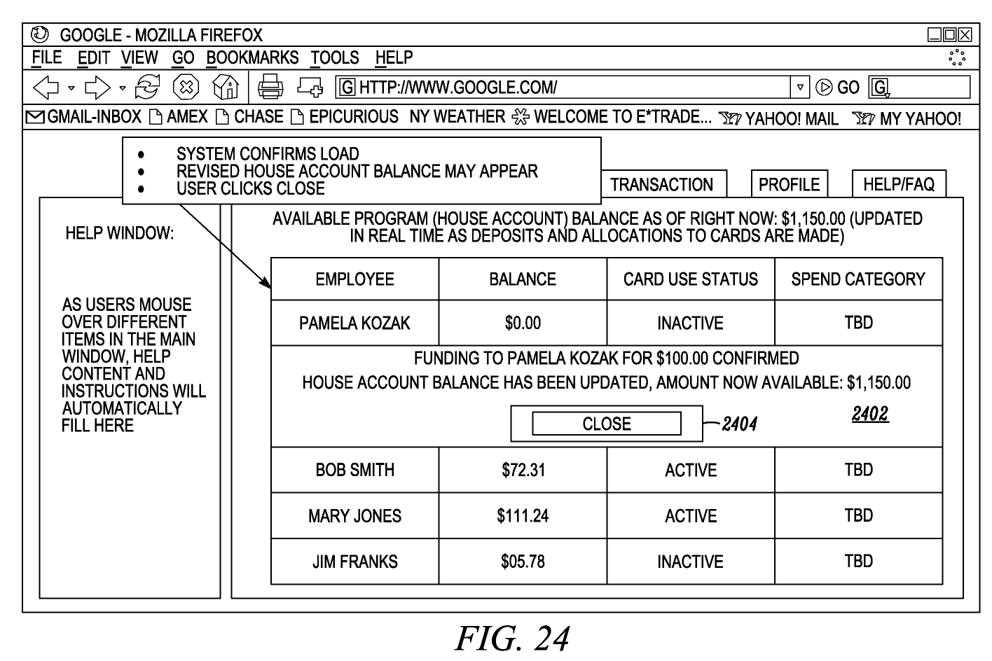

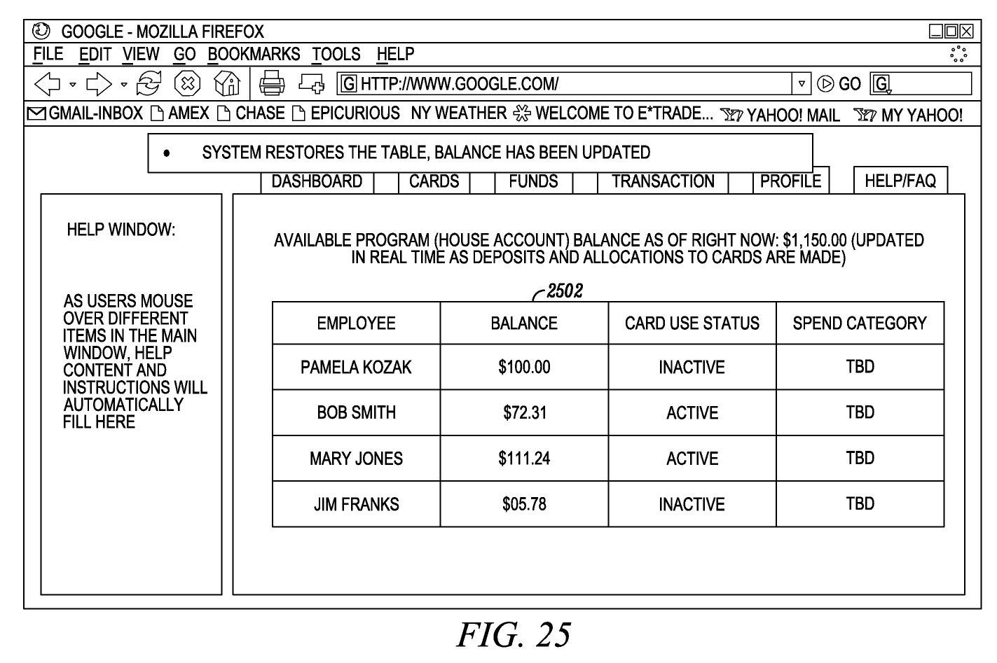

In embodiments, the GUI 122 may provide a plurality of additional user card management functions, such as for viewing transactions as shown in FIG. 21. A user may click on the name of a particular employee 2102 and in response the table may separate to reveal the previous ten most recent transactions of the employee 2104. In an embodiment, the GUI 122 may include a button for revealing all transactions 2108 of the particular employee. In embodiments, the GUI 122 may provide a plurality of additional user card management functions, such as for adding funds or auto funding as shown in FIGS. 22-25. Referring to FIG. 22, a user may click on the balance 2202 of a particular employee to issue funds. As a result, the table may separate to reveal options for funds management and present the current program funding balance 2204. The user may elect to add funds to the employee's account by clicking the “Add Funds” button 2208. FIG. 23 illustrates a particular embodiment of the GUI 122 presented in response to clicking the “Add Funds” button 2208. The employee may enter the amount to fund 2302 and then may click the “Add Funds” button 2208. As shown in FIG. 24, the system may confirm the added balance and provide an updated program funding balance 2402. The user may be presented with a “Close” button 2404 allowing the user to proceed. Once the “Close” button 2404 is clicked, the system may restore the table 2502 and display the updated information as shown in FIG. 25.

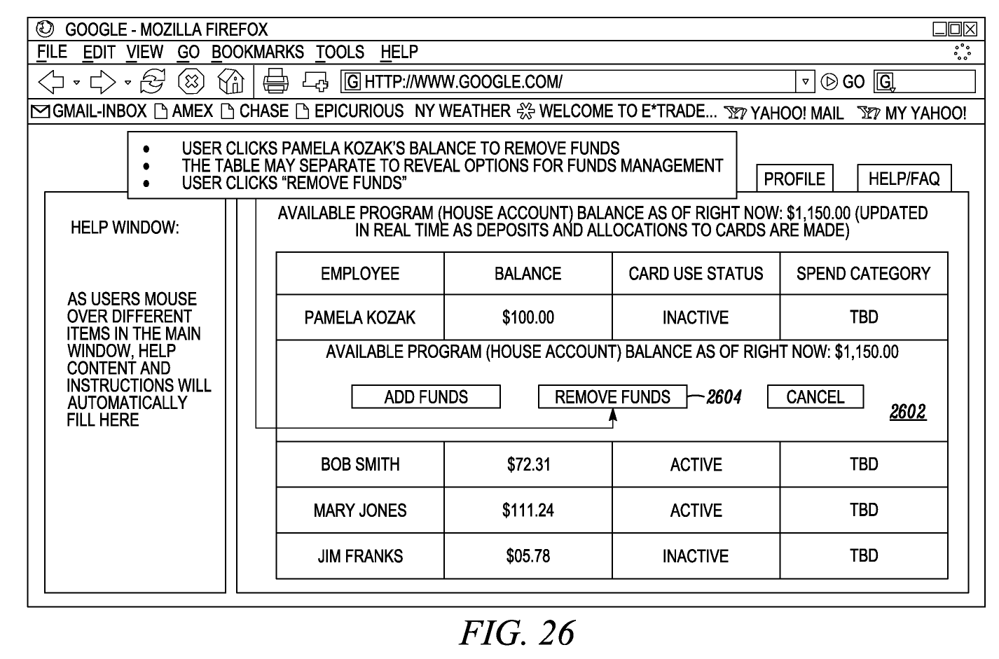

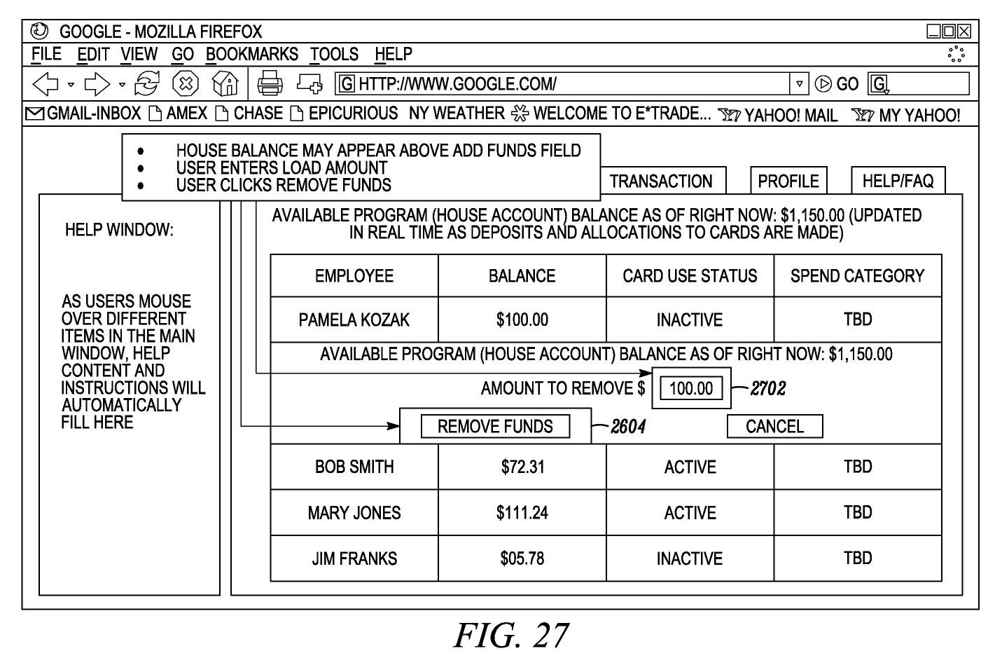

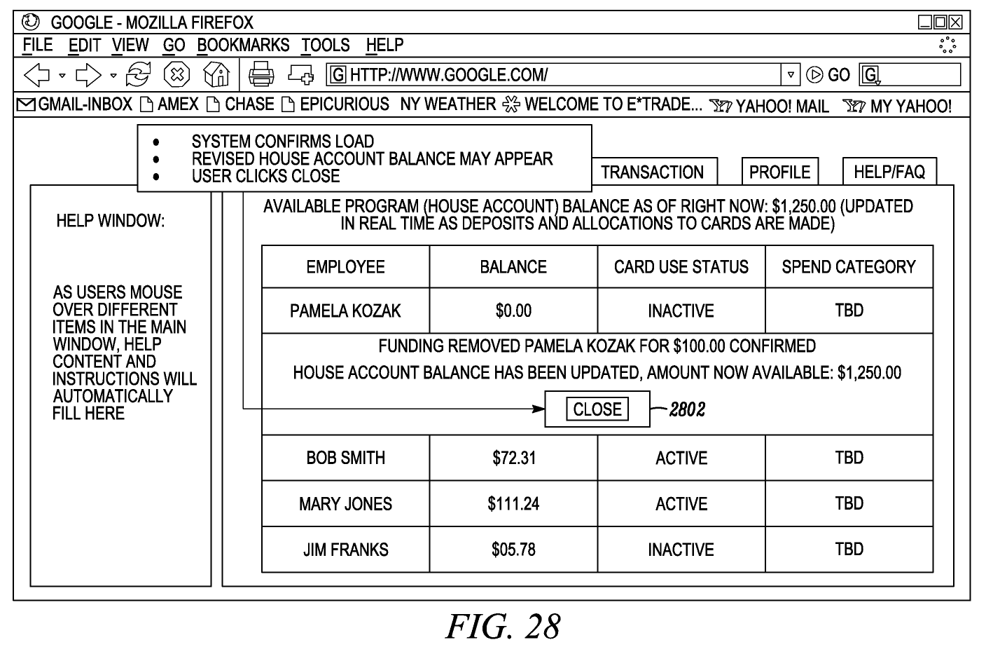

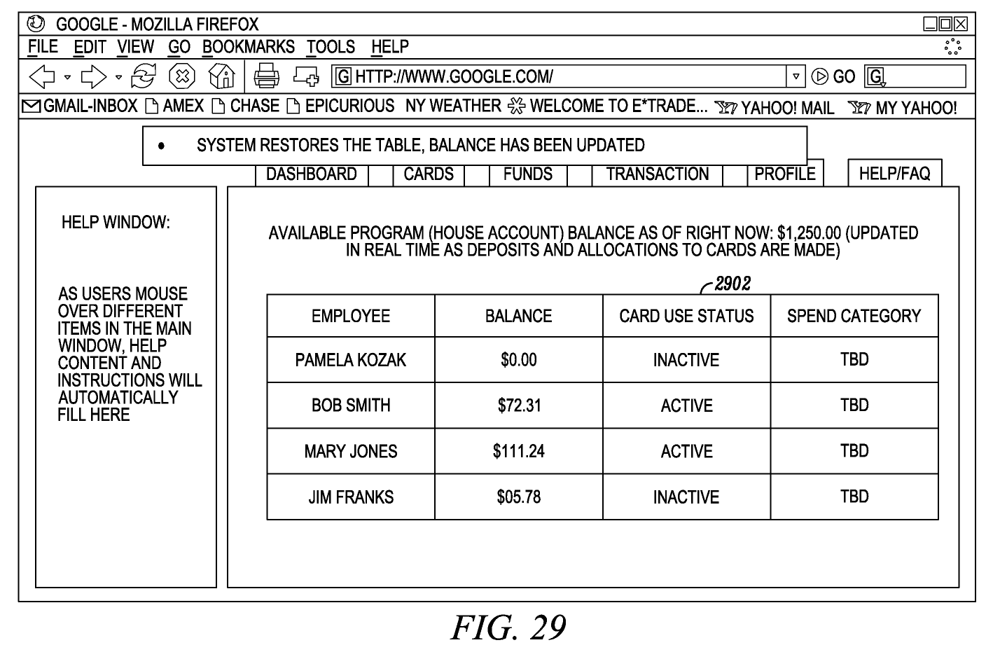

In embodiments, the GUI 122 may provide a plurality of additional user card management functions, such as for removing card funds as shown in FIGS. 26-29. A user may click on a employee's account balance and the table may separate presenting the user with options for adding and removing funds 2602. The user may click the “Remove Funds” button 2604 and, referring to FIG. 27, may be presented with a field for entering the amount of funds to remove 2702. The programming funding balance may also be displayed. The user may click the “Remove Funds” button 2604 to proceed. Referring to FIG. 28, the system may then confirm the change and the revised program funding balance may appear. The user may then click the “Close” button 2802 to proceed. Once the “Close” button 2802 is clicked, the system may restore the table 2902 and display the updated information as shown in FIG. 29.

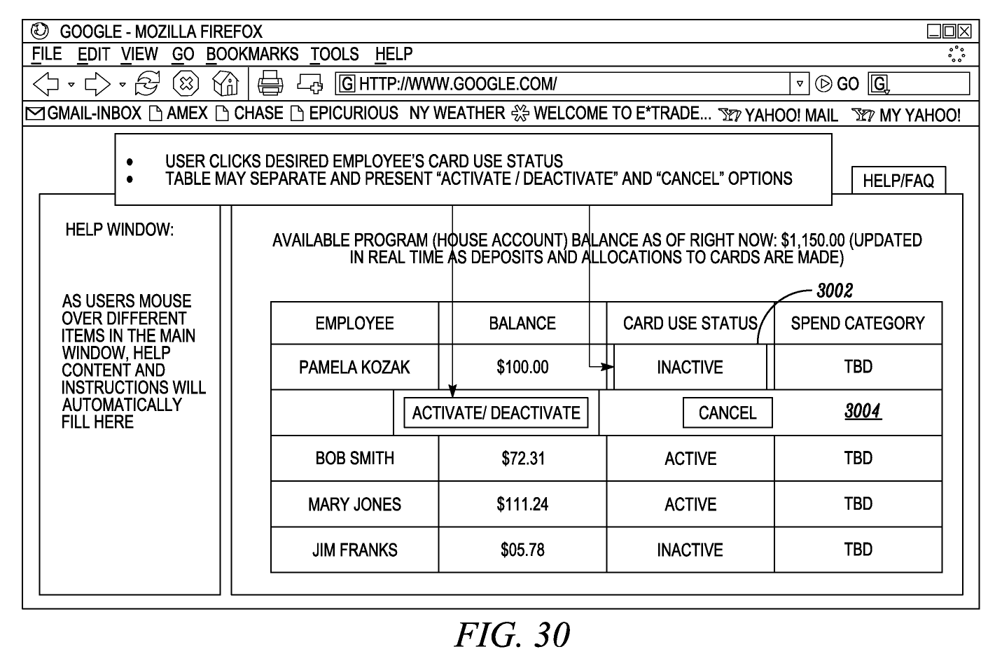

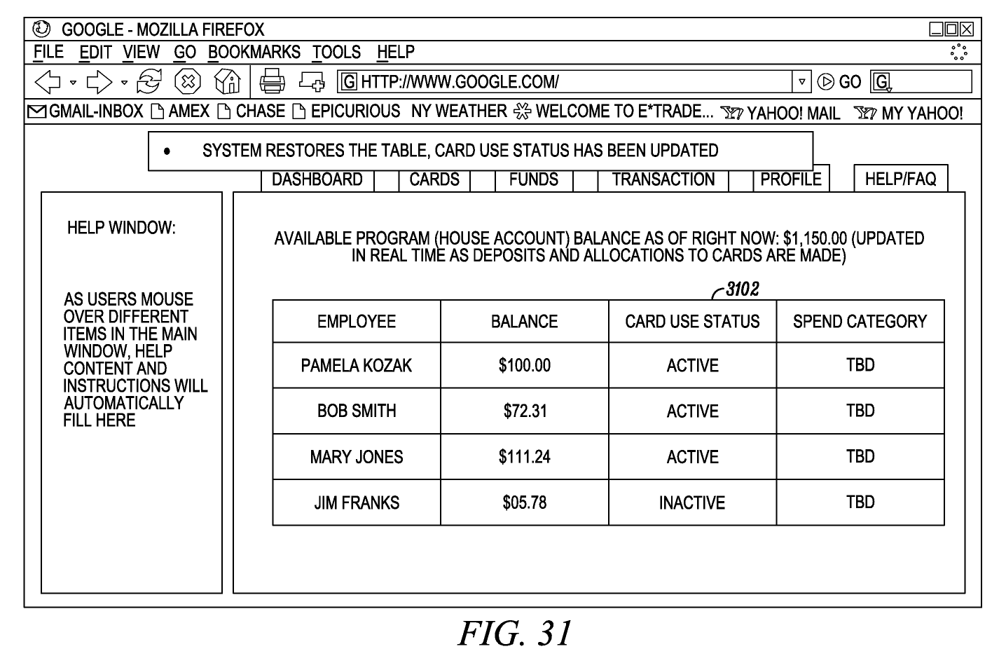

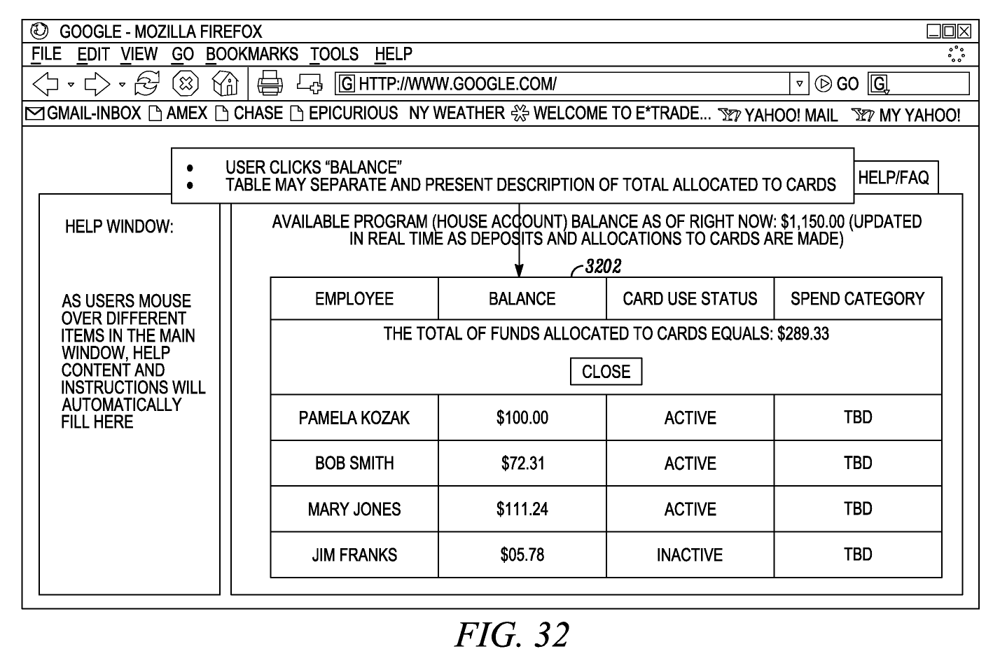

In embodiments, the GUI 122 may provide a plurality of additional user card management functions, such as for blocking/unblocking cardholder spend as shown in FIGS. 30-31. Referring to FIG. 30, a user may click on a desired employee's card use status 3002. As a result the table may separate and present “Activate/Deactivate” and “Cancel” options 3004. The user may click the “Activate/Deactivate” button to toggle the status and as shown in FIG. 31 the table 3102 may be restored with the updated card use status information. In embodiments, the GUI 122 may provide a plurality of additional user card management functions, such as for monitoring total funds on cards as shown in FIG. 32. Referring to FIG. 32, a user may click on the “Balance” column header 3202 to obtain a summary of the total balance allocated among the cards. In an embodiment, terminated employees (and/or contractors) may only be shown in certain views. In embodiments, the user may have the ability to customize the information that is presented in the user interface. The user interface may be characterized by a tree structure and a user may decide to hide aspects of the tree. In embodiments, the prepaid expense card management platform GUI 122 may provide a plurality of other functional interfaces within the system, and although only a select number of functional screens have been shown, they are meant to be examples of the prepaid expense card management platform GIU 122 and not limited to the functions discussed or illustrated.

The platform 102 may be associated with one or more payment networks 124. The payment network 124 may be associated with a credit card processor, such as Visa, MasterCard, American Express, Discover or the like, and may facilitate the transfer of funds from an issuing bank to a merchant at the point of sale. The payment network 124 may be an automated teller machine network, such as Plus, Cirrus, Star, Most, Nyce, Interlink, and the like, and may facilitate transfer of funds from an issuing bank to the cardholder in the form of cash. In embodiments, a transaction may travel through a payment network's 124 infrastructure to transact a purchase.

The prepaid expense card management platform 102 may include a reporting engine 128. The reporting engine 128 may allow for the generation of reports and summaries. The reports may be presented in the graphical user interface 122 or may be made separately available. In embodiments, reports may include a list, a user defined report, a pre-defined report, an expense report, a monthly statement, a graph, a chart, summary data, full detail data, a statement for a defined period, and the like. Reports may be generated for one account, a subset of accounts and/or for an entire business. The reporting engine 128 may allow a user to display, hear or download data. The report may be made available as a machine readable file, in a third party proprietary format (such as for Quicken, Quickbooks, Peachtree, MS Money, MS Small Business Management or the like), as email, as mobile message, as a voice message, as a customer service agent call, via an IVR/VRU, as a machine readable file for upload into an accounting or data management system and the like. In an embodiment, a report may be a cash flow report which may include the detail spent by user, by merchant, by merchant category, aggregate reports detailing all cardholder spending, cash inflows and outflows, and the like. The reports may be printable. The reporting engine 128 may allow for users to comment on and/or annotate reports. The reporting engine 128 may enable the creation, tracking and administration of audit trails. The reporting engine 128 may control access to audit trails, limit viewing of audit trails to those with a job-related need, protect audit trail files from unauthorized modifications and the like.

The prepaid expense card management platform 102 may include customer support functionality 130. Customer support 130 and product assistance may be offered via phone, email, instant message, chat, text message, forums, blogs, webinars or via any other means of communication. Customer support 130 may also include a knowledge base and other customer support material. Customer support 130 may play an integral role in managing customer relations. As the primary touch point between customers and the prepaid expense card management platform 102, this customer support 130 may need to be managed as meticulously as possible. To maintain maximum control over this aspect of the business, live operator support may be managed internally. Once a steady call stream is established, calls may be outsourced to a vendor that may offer comprehensive support 24 hours by 7 days. An IVR solution 132 may be integrated to automate frequent questions customers and cardholders may have. The option to speak with prepaid expense card management platform agents may be made available. In embodiments, calls for the prepaid expense card management platform 102 may be more likely to be related to system functionality rather than actual cardholder balances. Questions and inquires from program administrators may include setting card spend rules and limits, status of card delivery, status of program account funding, downloading to accounting software, and the like. Questions and inquires from card holders may include balance inquiries, inquires about cards not working at certain merchants due to spend rules set by their program administrators, assistance with transactions at the point of sale, and the like.

In embodiments, the platform 102 may include an integrated voice response (IVR) service 132. An IVR 132 may provide customer administrators with tools to manage all or certain prepaid expense card management platform features over the phone. The use of an IVR 132 will allow certain functions to be available from the field. Phone functionality may be provided via a toll free number. Cardholders may have access to the automated system to verify balance information, inquire about charges and request changes. The IVR system 132 may allow voice commands, touch tone phone commands, pulse phone commands and the like.

In embodiments, the platform 102 may include a billing engine 134. The billing engine 134 may administer program fees, including, without limitation, waiving fees, storing fee structures, modifying fee structures and the like. There may be a plurality of fees associated with the prepaid expense card management platform 102. Prepaid expense card management platform users may be offered a variety of pricing models to choose from, based on their frequency of use, and may be adjusted over time. Fees may be either recurring or non-recurring. Examples of non-recurring fees may be application processing fees, that cover the initial application review and for setting up the general prepaid expense card management platform account, registering bank information, and the like; card purchase fees whose cost is associated with buying cards; return funding fees that are associated with returning funds; replacement card fees; and the like. Recurring fees may be different for users based on their frequency of usage. The billing engine 134 may administer such fee arrangements.

In embodiments, a transactional pricing schedule may be available for users who use the card infrequently, such as 10 transactions or less per card per month. Transactional pricing may include fees such as a monthly card maintenance fee, a spend transaction fee, a customer support fee, overdraft fees, report fees, subscription fees associated with accounting software, and the like. In embodiments, a subscription pricing schedule may be available for users who use the card more frequently, such as more than 10 transactions per card per month. Subscription pricing may include fees such as a monthly card account fee, report fees, subscription fees associated with accounting software, and the like. In embodiments, users may be able to move between pricing schedules as facilitated by the billing engine 134. In embodiments, the billing engine 134 may compute and automatically apply the lowest cost pricing structure for a user or group of users.

The prepaid expense card management platform 102 may include an alert engine 138. The alert engine 138 may allow a business owner, administrator or other user to configure, receive and/or send alerts relating to any feature or aspect of the platform 102. An alert may be sent via email, fax, mail, mobile, text message, SMS, instant message, telephone, voicemail, RSS feed, posted to a graphical user interface, posted to a dashboard and the like. An alert may be interactive. A user may be able to respond to an alert. In an embodiment, a business owner may configure an alert that alerts an administrator when a particular employee's (and/or contractor's) card balance falls below a specified level. The alert may be sent via text message to the administrator and may allow the administrator to choose whether to fund the account. The administrator may submit his response by responding yes or no to the text message. In this regard, a business owner or administrator may maintain a high degree of control over the spending process with a reduced level of effort. In another embodiment, a user may send an alert to another user. In an embodiment, a sales rep may send an alert to an administrator asking for additional funds to be added to the sales rep's account, for spend approval, to have card or business spend rules modified or the like. In other embodiments, alerts may be sent to customer service representatives.

The prepaid expense card management platform 102 may include a search engine 140. The search engine 140 may enable the searching, filtering and clustering of information relating to transactions, users 148, spend rules and the like. The search engine 140 may enable the searching, filtering and clustering of information found in the forums, blogs and other community aspects 144 of the platform 102. The platform data may also be downloaded into other applications and searched using those applications.

The prepaid expense card management platform 102 may include a work flow engine 142. The work flow engine 142 may allow for the creation, manipulation and use of work flows. In embodiments, the work flow engine 142 may enable the creation of a work flow including, without limitation, the creation of a work flow ticket, the changing of work flow ticket status, the ability to attach document to work flow tickets, the ability to generate emails and notifications related to work flow tickets and the like. The work flow engine 142 may enable the use of work flows, including, without limitation, requests for business funding, requests for card funding, requests for spend authorization, new customer applications, application approval/decline notification, authorization, scoring of applications, identify verification and the like.

The prepaid expense card management platform 102 may include community aspects, forums, blogs and the like 144. In embodiments, users may be provided access to an interactive online or networked medium, where business owners, entrepreneurs and/or users of the prepaid expense card management platform 102 may draw from sources, such as colleagues and business advisors, to find answers to questions and solve business problems. In embodiments, resources other than online resources may be available to the user, such as through trade organizations, magazines, and the like. The online resource may provide users with a place to interact, such as to post questions or open online discussions in a forum; post to or view weblogs or blogs; access a weblog or blog written by a professional service provider such as an accountant, attorney or consultant, who can offer tips or other relevant information; provide and receive referrals; logon to presentations or webinars, such as quarterly web presentations, that may provide business owners and other users with tips to lower operational costs and improve expense management processes; and the like. The interactive medium may generate a community in a Web 2.0 fashion.

The prepaid expense card management platform 102 may be utilized by various groups and types of users 148. Users 148 may be business users, non-business users, households, entities, individuals, students and the like. Users 148 may be employees or agents of a business or company or a subset of a business or company, independent contractors, agents and the like. Users 148 may be members of a family or household and the like. Users 148 may be members or employees of a non-profit or government and the like. User 148 may be members of an organization.

In embodiments, access to the platform 102 may be provided using a web browser, client side program or the like. In embodiments, access to the platform 102 may be provided without the use of a web browser. Platform access 150, such as via the user interface, may be provided via a computer, network, laptop, handheld device, cell phone, wireless email device, Treo, Blackberry, personal digital assistant, palm top computer, pager, digital music player, voice interface, telephone and the like.

All aspects, functionalities and data associated with the platform 102 may be updated and varied in real-time 152. In an embodiment, changes in a card balance may be viewable in real-time 152. In embodiments, changes to spend rules may be implemented by the spend rules facility 112 in real-time 152. In embodiments, card status and approval requests may be received and reviewed in real-time 152. Real-time 152 updates may be provided via mobile, web, customer service and the like. Real-time 152 requests may be provided, received and/or processed via mobile, web, customer service and the like.

The elements depicted in flow charts and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these, and all such implementations are within the scope of the present disclosure. Thus, while the foregoing drawings and description set forth functional aspects of the disclosed systems, no particular arrangement of software for implementing these functional aspects should be inferred from these descriptions unless explicitly stated or otherwise clear from the context.

Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods or processes described above, and steps thereof, may be realized in hardware, software, or any combination of these suitable for a particular application. The hardware may include a general-purpose computer and/or dedicated computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as computer executable code created using a structured programming language such as C, an object oriented programming language such as C++, HTML, web XML, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

While the invention has been described in connection with certain preferred embodiments, other embodiments would be understood by one of ordinary skill in the art and are encompassed herein.

All documents referenced herein are hereby incorporated by reference.

1. A method of managing expenses using prepaid cards, comprising:
Providing a first account managed by a prepaid expense card management platform embodied in computer executable code to be executed using a processor;
Providing at least one other account managed by the prepaid expense card management platform; and
Providing an account administration facility for allowing a user of the first account to perform at least one administrative action in connection with the at least one other account.

2. The method of claim 1, wherein a prepaid expense card is associated with the at least one other account.

3. The method of claim 1, wherein the first account is a root account and the at least one other account comprises the accounts of at least two separate businesses.

4. The method of claim 1, wherein the first account is an account of a particular business and the at least one other account is an account of the same business.

5. The method of claim 1, wherein the at least one administrative action is selected from the group consisting of creating an account, terminating an account and blocking an account.

6-7. (canceled)

8. The method of claim 1, further comprising, providing a dashboard which displays information and can receive input associated with the at least one administrative action.

9-35. (canceled)

36. A method of managing expenses using prepaid cards, comprising:
Providing a first account managed by a prepaid expense card management platform embodied in computer executable code to be executed using a processor;
Providing at least one other account managed by the prepaid expense card management platform; and
Providing a funds management facility which transfers funds between the first account and the at least one other account.

37. The method of claim 36, wherein the funds are transferred based on a pre-defined rule.

38-39. (canceled)

40. The method of claim 36, wherein the funds are transferred on a pre-determined schedule.

41-42. (canceled)

43. The method of claim 36, wherein the funds are transferred in response to a certain event.

44. The method of claim 43, wherein the event is at least one of the transfer of funds to and the removal of funds from the first account.

45. (canceled)

46. The method of claim 43, wherein the event is a change in the balance of the at least one other account.

47-50. (canceled)

51. The method of claim 36, wherein a prepaid expense card is associated with the at least one other account.

52. (canceled)

53. A method of managing expenses using prepaid cards, comprising:
Providing at least one account managed by a prepaid expense card management platform embodied in computer executable code to be executed using a processor;
Issuing at least one prepaid expense card associated with the at least one account to at least one user; and
Providing a spend rules facility for the administration of at least one spend rule in association with the at least one account.

54. The method of claim 53, wherein the administration of at least one spend rule involves at least one of the creation management and modification of spend rules.

55-56. (canceled)

57. The method of claim 53, wherein the at least one spend rule relates to at least one an attribute selected from the group consisting of: MCC, category of expenditure, amount of expenditure, amount of series of expenditures, amount per transaction, frequency of expenditures, day of the week, time of day, employee working hours, contractor working hours, geographical zones, locations, and gratuity rules.

58. The method of claim 53, further comprising, providing a communication facility through which the at least one user may request changes to at least one spend rule.

59-60. (canceled)

61. The method of claim 53, further comprising, providing a communication facility through which the at least one user may obtain information regarding at least one spend rule.

62-67. (canceled)

68. The method of claim 53, wherein the spend rules facility represents the at least one spend rule in a graphical user interface.

69-77. (canceled)

78. The method of claim 53, wherein the user is not the owner of funds associated with the prepaid expense card issued to the user.

79-106. (canceled)
